(19) United States
(12) Patent Application Publication
(10) Pub. No.: US 2012/0019081 A1
(43) Pub. Date: Jan. 26, 2012

(54) STATOR FOR ELECTRIC ROTATING MACHINE

(75) Inventors: Akito Tamura, Kariya-shi (JP); Shinji Kouda, Kariya-shi (JP)

(73) Assignee: DENSO CORPORATION, Kariya-city (JP)

(21) Appl. No.: 13/186,752

(22) Filed: Jul. 20, 2011

(30) Foreign Application Priority Data
Jul. 20, 2010 (JP) 2010-162845

(51) Int. Cl. H02K 3/30; H02K 3/28

(52) U.S. Cl. 310/43; 310/71

(57) ABSTRACT

A stator includes an annular stator core and a stator coil. The stator coil is formed of a plurality of electric wires mounted on the stator core. The stator coil has a coil end part that protrudes from an axial end face of the stator core so as to be located outside slots of the stator core. The electric wires forming the stator coil are grouped into a plurality of electric wire sets. Each of the electric wire sets consists of a predetermined number of the electric wires which are electrically connected to one another. The stator coil further includes a plurality of bridging wires. Each of the bridging wires extends, on an axially outer periphery of the coil end part of the stator coil, to electrically connect a corresponding pair of the electric wire sets. Further, at least two of the bridging wires are fixed to one another.

### CROSS-REFERENCE TO RELATED APPLICATION

This application is based on and claims priority from Japanese Patent Application No. 2010-162845, filed on Jul. 20, 2010, the content of which is hereby incorporated by reference in its entirety into this application.

### BACKGROUND OF THE INVENTION

1. Technical Field of the Invention

The present invention relates to stators for electric rotating machines that are used in, for example, motor vehicles as electric motors and electric generators.

2. Description of the Related Art

Japanese Patent Application Publication No. 2010-11623 discloses an electric rotating machine which includes a rotor and a stator.

The stator includes an annular stator core and a three-phase stator coil. The stator core is disposed so as to surround the rotor. The stator coil includes a plurality of phase windings and a plurality of bridging wires. Each of the phase windings is comprised of a plurality of electric wires that are mounted on the stator core and electrically connected to one another. Each of the bridging wires electrically connects a corresponding pair of the phase windings. The bridging wires are located on the axially outer periphery of a coil end part of the stator coil; the coil end part protrudes from an axial end face of the stator core. Moreover, the bridging wires extend so that the circumferential positions of the bridging wires partially overlap one another.

With the above configuration, during operation of the electric rotating machine, the stator coil will vibrate due to the Lorentz force and external vibrational load, thereby causing adjacent pairs of the bridging wires to collide or slide against each other. Consequently, the insulating coats of the bridging wires may be damaged, thereby lowering the insulation properties of the stator coil. As a result, the stator may become unable to function normally in the electric rotating machine.

### SUMMARY OF THE INVENTION

According to the present invention, there is provided a stator for an electric rotating machine which includes an annular stator core and a stator coil. The stator core has a plurality of slots that are formed in the radially inner surface of the stator core and spaced in the circumferential direction of the stator core. The stator coil is formed of a plurality of electric wires mounted on the stator core. The stator coil has a coil end part that protrudes from an axial end face of the stator core so as to be located outside the slots of the stator core. The electric wires forming the stator coil are grouped into a plurality of electric wire sets. Each of the electric wire sets consists of a predetermined number of the electric wires which are electrically connected to one another. The stator coil further includes a plurality of bridging wires. Each of the bridging wires extends, on an axially outer periphery of the coil end part of the stator coil, to electrically connect a corresponding pair of the electric wire sets. Further, at least two of the bridging wires are fixed to one another.

With the above configuration, during operation of the electric rotating machine, it is possible to effectively suppress displacement of the bridging wires due to vibration of the stator. Consequently, it is possible to reliably prevent adjacent pairs of the bridging wires from colliding or sliding against each other, thereby ensuring high insulation properties of the stator coil.

In further implementations of the invention, the at least two bridging wires may be fixed to one another by a fixing material provided therebetween. In this case, it is preferable that the fixing material is a resin. It is further preferable that the fixing material is a thermosetting resin, It is also preferable that the fixing material is provided between a facing pair of flat side surfaces of the at least two bridging wires so as to keep the side surfaces parallel to each other.

Also, the at least two bridging wires may be pressure-joined to one another. In this case, it is preferable that an elastic member is interposed between the at least two bridging wires.

The at least two bridging wires which are fixed to one another preferably include those two of the plurality of bridging wires which are positioned axially outermost in all the bridging wires.

The stator coil may be a three-phase stator coil. Among the plurality of electric wire sets, three of them may each have a neutral terminal formed therein. The neutral terminals may be connected together to define a neutral point of the stator coil. In this case, it is preferable that the at least two bridging wires which are fixed to one another include one of the plurality of bridging wires which electrically connects two of the neutral terminals.

It is more preferable that all of the plurality of bridging wires are fixed to one another.

Preferably, each of the plurality of bridging wires is comprised of an electric conductor and an insulating coat that covers the electric conductor.

Preferably, each of the plurality of bridging wires has a substantially rectangular cross section perpendicular to the longitudinal direction of the bridging wire. The at least two bridging wires have their respective side surfaces fixed to each other.

More preferably, each of the plurality of bridging wires has a pair of wider side surfaces and a pair of narrower side surfaces, the wider side surfaces having a larger width than the narrower side surfaces. The at least two bridging wires have their respective wider side surfaces fixed to each other.

The stator core may be comprised of a plurality of stator core segments that are fixed together so as to adjoin one another in the circumferential direction of the stator core.

The stator may further include a connector that includes a resin in which the plurality of bridging wires are insert-molded.

### BRIEF DESCRIPTION OF THE DRAWINGS

The present invention will be understood more fully from the detailed description given hereinafter and from the accompanying drawings of preferred embodiments of the invention, which, however, should not be taken to limit the invention to the specific embodiments but are for the purpose of explanation and understanding only.

In the accompanying drawings:

FIG. 1 is a perspective view of a stator for an electric rotating machine according to the first embodiment of the invention;

FIG. 2 is a top view of the stator;

FIG. 3 is a side view of the stator;

FIG. 4 is a top view of a stator core of the stator;

FIG. 5 is a top view of one of stator core segments which together make up the stator core;

FIG. 6 is a perspective view of a stator coil of the stator;

FIG. 7 is a side view of the stator coil;

FIG. 8 is a top view of the stator coil;

FIG. 9 is a bottom view of the stator coil;

FIG. 10A is a cross-sectional view illustrating the configuration of electric wires forming the stator coil;

FIG. 10B is a cross-sectional view illustrating a modification of the configuration of the electric wires shown in FIG. 10A;

FIG. 11A is a top view of one of the electric wires;

FIG. 11B is a front view of the one of the electric wires;

FIG. 12A is a perspective view illustrating a turn portion of one of the electric wires;

FIG. 12B is a perspective view illustrating a plurality of turn portions of the electric wires which are adjacent to one another;

FIG. 13A is a bottom view of an electric wire assembly comprised of the electric wires for forming the stator coil;

FIG. 13B is a front view of the electric wire assembly;

FIG. 13C is a perspective view illustrating one of the electric wires in the electric wire assembly after the electric wire assembly is rolled into a hollow cylindrical shape;

FIG. 14 is a circuit diagram of the stator coil;

FIG. 15 is a schematic view illustrating the location of the radially-outermost in-slot portion of each of the electric wires in the stator core;

FIG. 16 is a schematic view illustrating the manner of extension of the electric wire labeled (U1-4′) when viewed along the longitudinal axis O of the stator core;

FIG. 17 is a tabular representation showing both the number of the electric wire located at the radially outermost layer and the number of the electric wire located at the radially innermost layer in each of the slots of the stator core;

FIG. 18 is a schematic view illustrating the connection between those of the electric wires which together form a V-phase winding of the stator coil when viewed from the radially inner side of the stator core;

FIG. 19A is a top view of first to fifth bridging wires of the stator coil;

FIG. 19B is a cross-sectional view taken along the line I-I in FIG. 19A;

FIG. 20 is an exploded perspective view of part of the stator, wherein the first to the fifth bridging wires are separated from the rest of the stator;

FIG. 21A is a top view of first to fifth bridging wires of a stator coil according to the second embodiment of the invention;

FIG. 21B is a cross-sectional view taken along the line II-II in FIG. 21A;

FIG. 22 is a cross-sectional view illustrating a first modification to the stator coil according the second embodiment;

FIG. 23 is a cross-sectional view illustrating a second modification to the stator coil according the second embodiment;

FIG. 24 is a cross-sectional view illustrating a third modification to the stator coil according the second embodiment;

FIG. 25 is a top view of a connector according to the third embodiment of the invention;

FIG. 26A is a perspective view of first to fifth bridging wires insert-molded in a resin of the connector;

FIG. 26B is a perspective view of the connector; and

FIG. 27 is an exploded perspective view of part of a stator according to the third embodiment, wherein the connector is separated from the rest of the stator.

### DESCRIPTION OF PREFERRED EMBODIMENTS

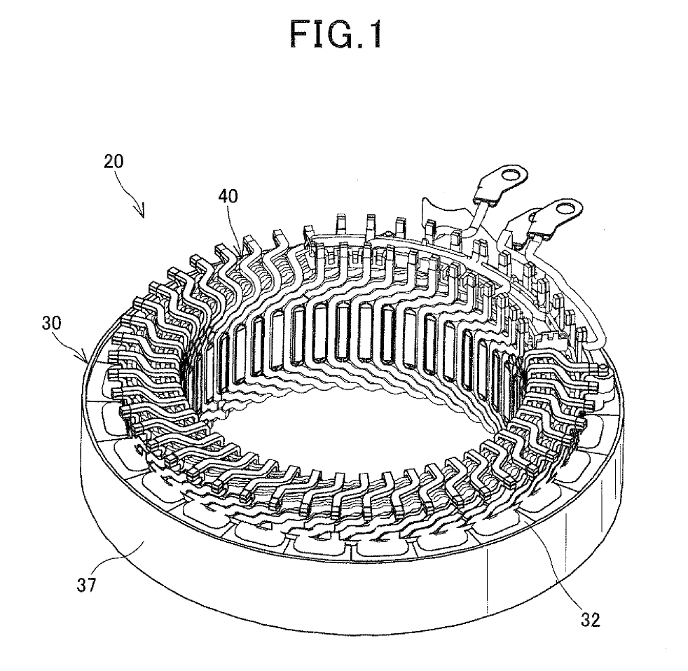

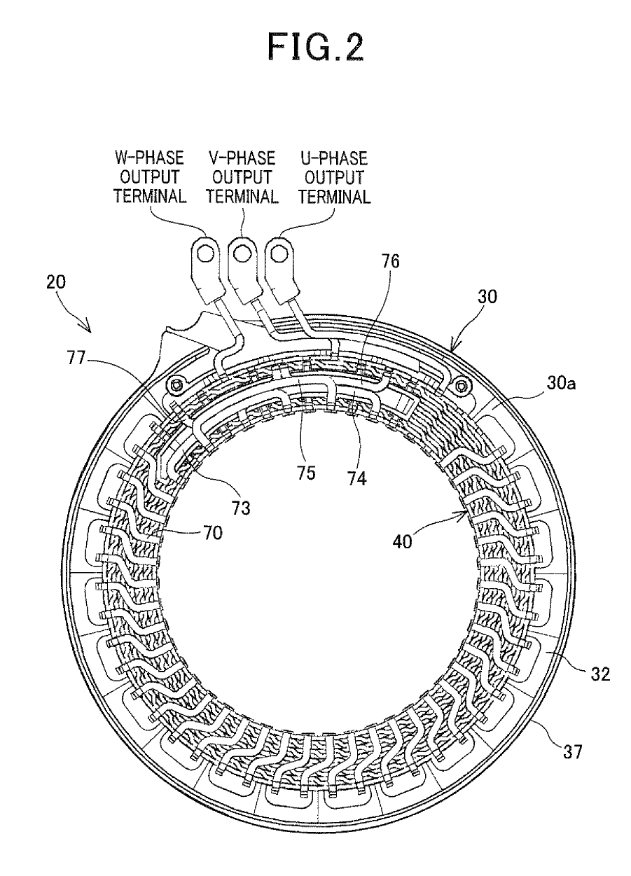

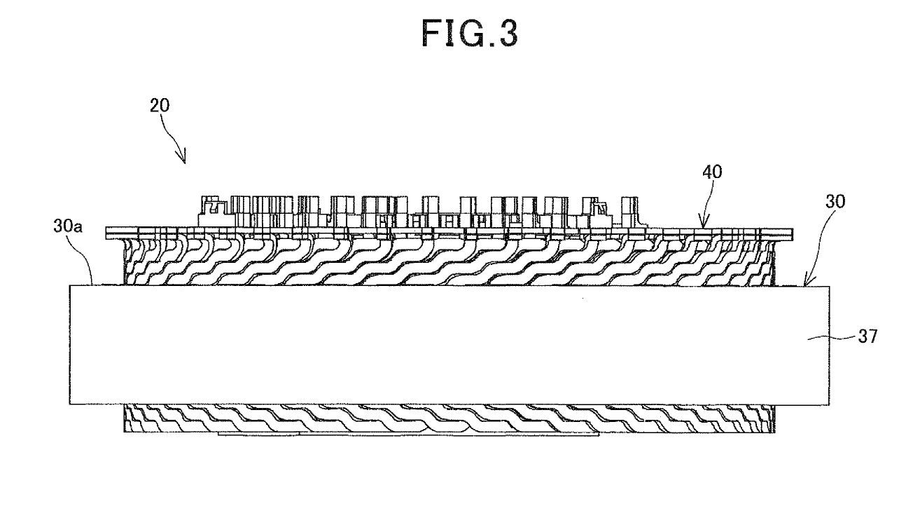

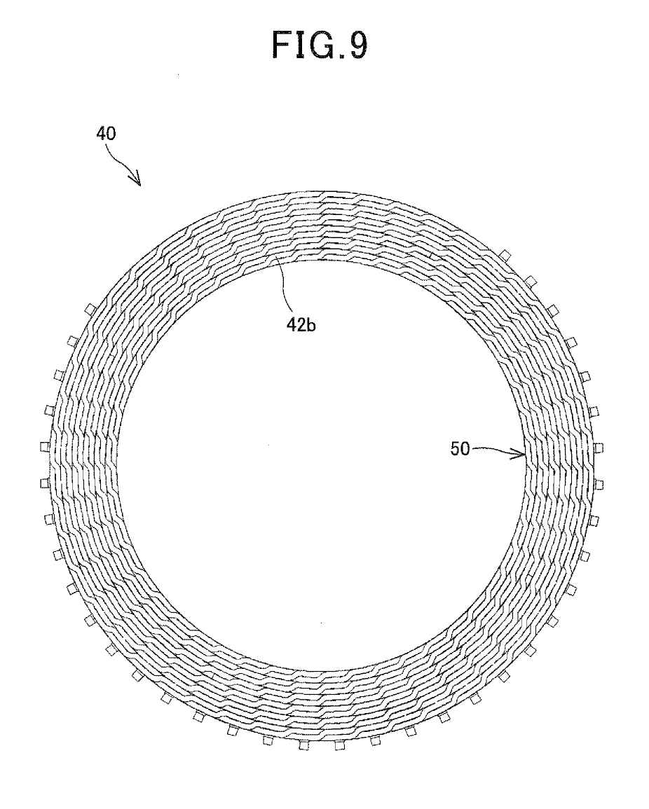

Preferred embodiments of the present invention will be described hereinafter with reference to FIGS. 1-27. It should be noted that for the sake of clarity and understanding, identical components having identical functions in different embodiments of the invention have been marked, where possible, with the same reference numerals in each of the figures and that for the sake of avoiding redundancy, descriptions of the identical components will not be repeated.

### First Embodiment

FIGS. 1-3 together show the overall configuration of a stator 20 according to a first embodiment of the invention. The stator 20 is designed for use in, for example, an electric rotating machine which is configured to function both as an electric motor and as an electric generator in a motor vehicle. The electric rotating machine further includes a rotor (not shown) that is rotatably disposed so as to be surrounded by the stator 20. The rotor includes a plurality of permanent magnets that form a plurality of magnetic poles on a radially outer periphery of the rotor to face a radially inner periphery of the stator. The polarities of the magnetic poles alternate between north and south in the circumferential direction of the rotor. In addition, in the present embodiment, the number of the magnetic poles formed in the rotor is equal to eight (i.e., four north poles and four south poles).

As shown in FIGS. 1-3, the stator 20 includes an annular stator core 30 and a three-phase stator coil 40 that is comprised of a plurality of (e.g., 48 in the present embodiment) electric wires 50 mounted on the stator core 30. In addition, the stator 20 may further have insulating paper interposed between the stator core 30 and the stator coil 40.

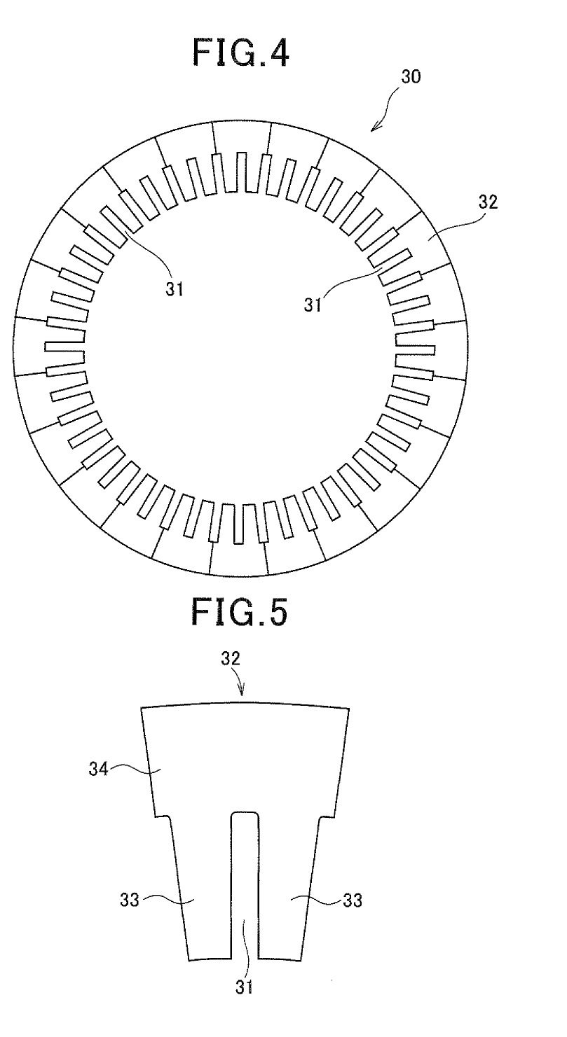

The stator core 30 has, as shown in FIG. 4, a plurality of slots 31 that are formed in the radially inner surface of the stator core 30 and spaced in the circumferential direction of the stator core 30 at a predetermined pitch. For each of the slots 31, the depth-wise direction of the slot 31 coincides with a radial direction of the stator core 30. In the present embodiment, there are provided two slots 31 per magnetic pole of the rotor that has the eight magnetic poles and per phase of the three-phase stator coil 40. Accordingly, the total number of the slots 31 provided in the stator core 30 is equal to 48 (i.e., 2×8×3).

Moreover, in the present embodiment, the stator core 30 is made up of, for example, 24 stator core segments 32 as shown in FIG. 5. The stator core segments 32 are fixed together so as to adjoin one another in the circumferential direction of the stator core 30. Each of the stator core segments 32 defines therein one of the slots 31. Further, each circumferentially-adjoining pair of the stator core segments 32 together defines a further one of the slots 31 therebetween. Each of the stator core segments 32 also has two tooth portions 33, which radially extend so as to form the one of the slots 31 therebetween, and a back core portion 34 that is located radially outward of the tooth portions 33 to connect them. In addition, on the radially outer surfaces of the stator core segments 32, there is fitted a cylindrical outer ring 37 (shown in FIGS. 1-3) by which the stator core segments 32 are fastened together.

In the present embodiment, each of the stator core segments 32 is formed by laminating a plurality of magnetic steel sheets with a plurality of insulating films interposed therebetween. It should be noted that other conventional metal sheets may also be used instead of the magnetic steel sheets.

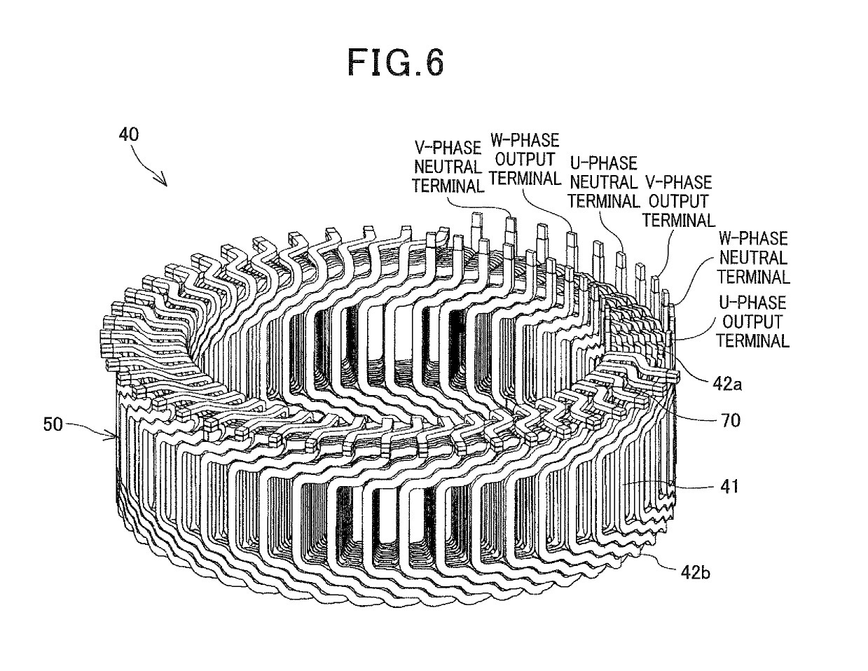

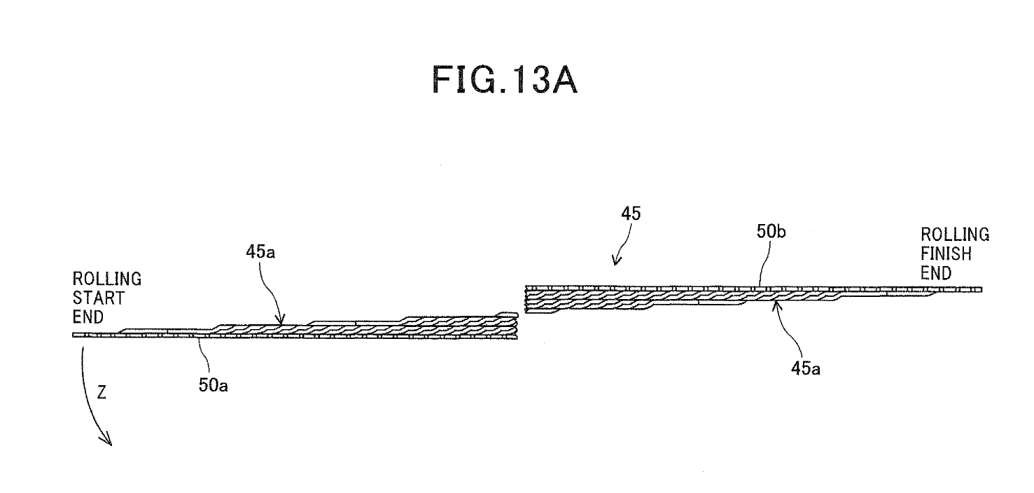

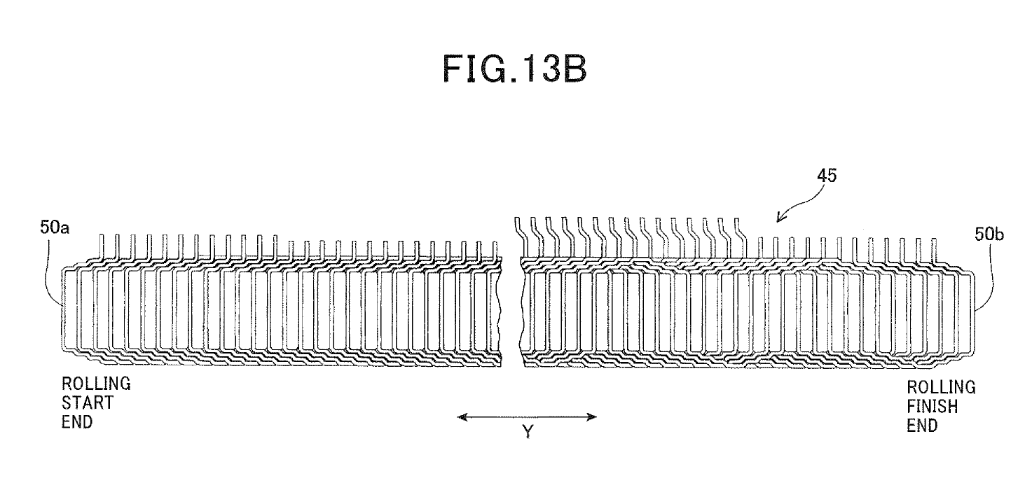

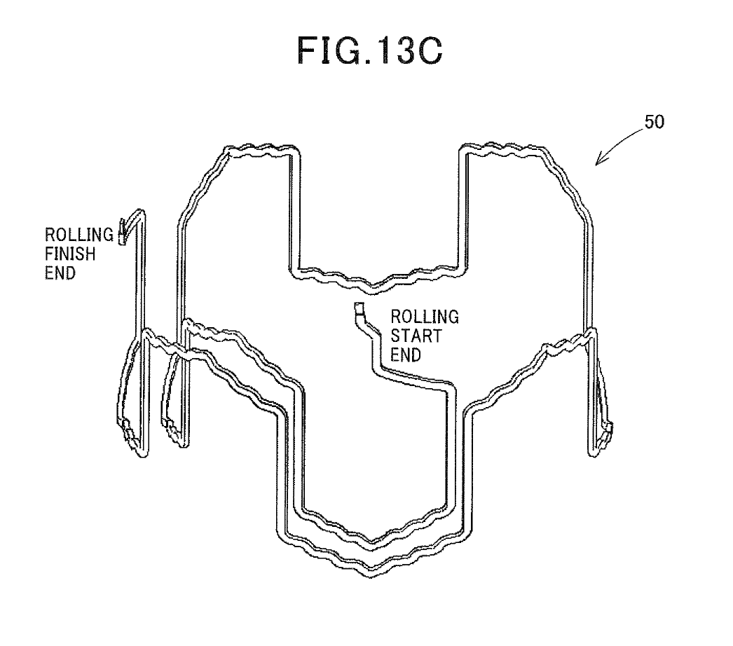

FIGS. 6-9 together show the configuration of the stator coil 40. In the present embodiment, as to be described in detail later, the stator coil 40 is produced by first stacking the 48 electric wires 50 to form a band-shaped electric wire assembly 45 as shown in FIGS. 13A-13B and then rolling the electric wire assembly 45 into a hollow cylindrical shape.

As shown in FIGS. 6-9, the stator coil 40 has, as a whole, a straight part 41 to be received in the slots 31 of the stator core 30, and a pair of coil end parts 42a and 42b that are respectively formed on opposite axial sides of the straight part 41 and to be located outside of the slots 31. Moreover, on one axial side of the straight part 41, U-phase, V-phase and W-phase output terminals and U-phase, V-phase and W-phase neutral terminals of the stator coil 40 protrude from the annular axial end face of the coil end part 42a, and a plurality of crossover parts 70 of the electric wires 50 cross over the axial end face from the radially inner side to the radially outer side of the axial end face to connect corresponding pairs of the electric wires 50.

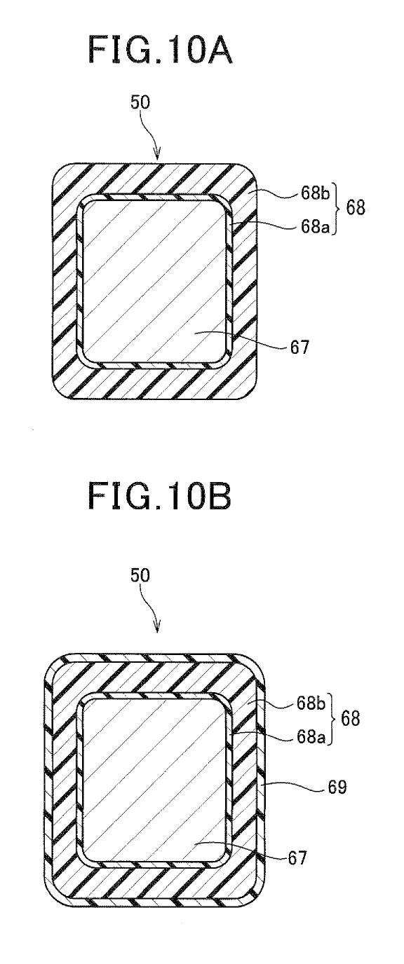

Each of the electric wires 50 for forming the stator coil 40 is configured with, as shown in FIG. 10A, an electric conductor 67 and an insulating coat 68 that covers the outer surface of the electric conductor 67. In the present embodiment, the electric conductor 67 is made of copper and has a substantially rectangular cross section. The insulating coat 68 is two-layer structured to include an inner layer 68a and an outer layer 68b. The thickness of the insulating coat 68 (i.e., the sum of thicknesses of the inner and outer layers 68a and 68b) is set to be in the range of 100 to 200 μm.

With such a large thickness of the two-layer structured insulating coat 68, it is possible to reliably insulate the electric wires 50 from one another without interposing insulating paper therebetween. However, it is also possible to interpose insulating paper between the electric wires 50 so as to further enhance the electrical insulation therebetween.

Further, the outer layer 68b is made of an insulating material such as nylon. The inner layer 68a is made of a thermoplastic resin having a higher glass transition temperature than the outer layer 68b or an insulating material having no glass transition temperature such as a polyamide-imide resin. Consequently, the outer layers 68b of the electric wires 50 will be solidified by the heat generated by operation of the electric rotating machine earlier than the inner layers 68a. As a result, the surface hardness of the outer layers 68b will be increased, thereby enhancing the electrical insulation between the electric wires 50.

Furthermore, as shown in FIG. 10B, it is also possible for each of the electric wires 50 to further include a fusible coat 69 to cover the outer surface of the insulating coat 68; the fusible coat 69 may be made, for example, of epoxy resin. In this case, the fusible coats 69 of the electric wires 50 will be fused by the heat generated by operation of the electric rotating machine earlier than the insulating coats 68, thereby bonding together those portions of the electric wires 50 which are received in the same ones of the slots 31 of the stator core 30. As a result, those portions of the electric wires 50 will be integrated into a rigid body, thereby enhancing the mechanical strength thereof. In addition, the outer layers 68b of the insulating coats 68 of the electric wires 50 may also be made of PPS (polyphenylene sulfide).

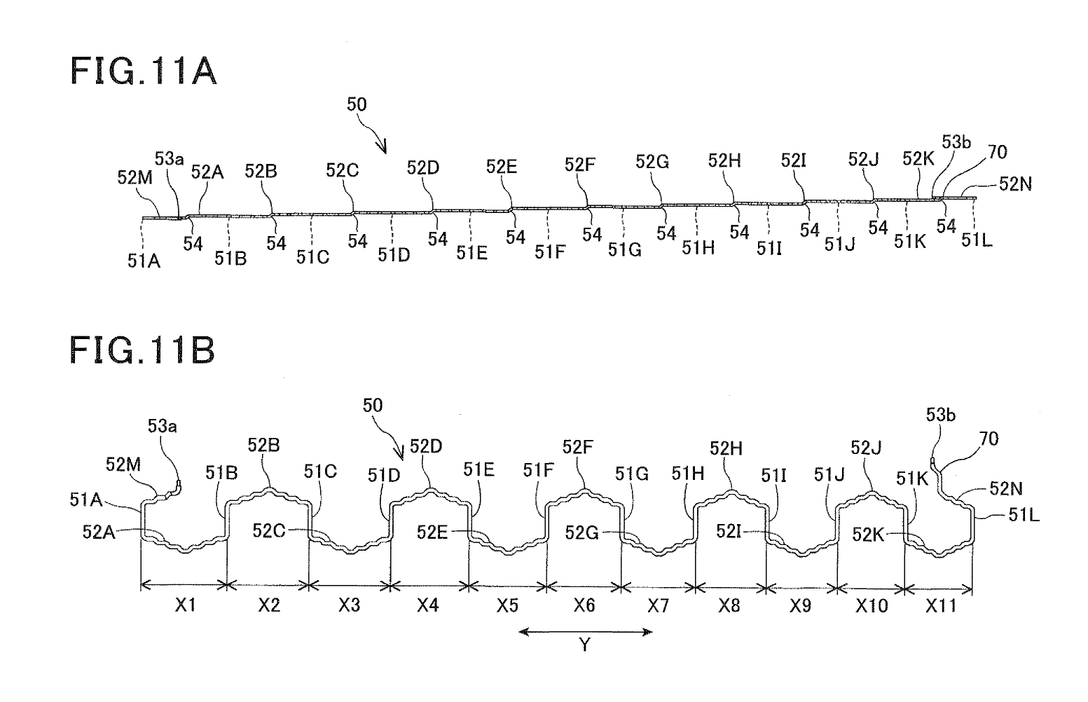

FIGS. 11A-11B together show the shape of each of the electric wires 50 before the electric wires 50 are stacked to form the band-shaped electric wire assembly 45.

As shown in FIGS. 11A-11B, each of the electric wires 50 is wave-shaped to include a plurality of in-slot portions 51 and a plurality of turn portions 52. The in-slot portions 51 are spaced in the longitudinal direction Y of the electric wire 50 at predetermined pitches and extend perpendicular to the longitudinal direction Y. Each of the in-slot portions 51 is to be received in a corresponding one of the slots 31 of the stator core 30. Each of the turn portions 52 extends to connect a corresponding adjacent pair of the in-slot portions 51 and is to be located outside of the slots 31 of the stator core 30.

Specifically, the plurality of in-slot portions 51 include, at least, a first in-slot portion 51A, a second in-slot portion 51B, and a third in-slot portion 51C. The first, second and third in-slot portions 51A, 51B, and 51C are to be respectively received in three different slots 31 of the stator core 30; the three slots 31 are circumferentially spaced at a pitch of six slots 31. On the other hand, the plurality of turn portions 52 include, at least, a first turn portion 52A and a second turn portion 52B. The first turn portion 52A connects the first and second in-slot portions 51A and 51B and is to be located on one axial side of the stator core 30 outside of the slots 31. The second turn portion 52B connects the second and third in-slot portions 51B and 51C and is to be located on the other axial side of the stator core 30 outside of the slots 31.

More specifically, in the present embodiment, as shown in FIGS. 11A-11B, the plurality of in-slot portions 51 include first to twelfth in-slot portions 51A-51L which are to be sequentially received in eight slots 31 that are circumferentially spaced at a pitch of six slots 31. In other words, the number of the in-slot portions 51 in each of the electric wires 50 is equal to 12. On the other hand, the plurality of turn portions 52 include first to eleventh turn portions 52A-52K which each connect a corresponding adjacent pair of the in-slot portions 51A-51L and are to be alternately located on the opposite axial sides of the stator core 30 outside the slots 31. In other words, the number of the turn portions 52 in each of the electric wires 50 is equal to 11.

Moreover, the predetermined pitches X between the in-slot portions 51A-51L in the longitudinal direction Y of the electric wire 50 gradually decrease in a direction from the first in-slot portion 51A to the twelfth in-slot portion 51L. That is, X1>X2>X3>X4>X5>X6>X7>X8>X9>X10>X11. In addition, the predetermined pitches X1-X11 are set based on the circumferential distances between the eight slots 31 of the stator core 30 in which the in-slot portions 51A-51L are to be received.

Each of the electric wires 50 further includes a pair of lead portions 53a and 53b that are respectively formed at opposite ends of the electric wire 50 for connecting the electric wire 50 with other electric wires 50. The lead portion 53a is connected to the first in-slot portion 51A via a half-turn portion 52M that extends from the first in-slot portion 51A to return inward (i.e., rightward in FIG. 11B) in the longitudinal direction Y of the electric wire 50. The length of the half-turn portion 52M is substantially half the length of the first turn portion 52A. Consequently, the lead portion 53a is offset inward (i.e., rightward in FIG. 11B) in the longitudinal direction Y from the first in-slot portion 51A by the length of the half-turn portion 52M. On the other hand, the lead portion 53b is connected to the twelfth in-slot portion 51L via a half-turn portion 52N that extends from the twelfth in-slot portion 51L to return inward (i.e., leftward in FIG. 11B) in the longitudinal direction Y of the electric wire 50. The length of the half-turn portion 52N is substantially half the length of the eleventh turn portion 52K. Consequently, the lead portion 53b is offset inward (i.e., leftward in FIG. 11B) in the longitudinal direction Y from the twelfth in-slot portion 51L by the length of the half-turn portion 52N. Further, the lead portion 53b is formed to include therein one of the crossover parts 70 described previously.

Furthermore, as shown in FIG. 11A, each of the turn portions 52 includes, substantially at the center thereof, a crank-shaped part 54 that is bent to offset the turn portion 52 in a direction perpendicular to both the longitudinal direction Y of the electric wire 50 and the extending direction of the in-slot portions 51. Consequently, with the crank-shaped parts 54, the electric wire 50 is stepped to successively offset the in-slot portions 51 in the direction perpendicular to both the longitudinal direction Y and the extending direction of the in-slot portions 51. It should be noted that the term “crank-shaped” is used here only for the purpose of describing the overall shape of the parts 54 and does not restrict the internal angles between adjacent sections of the parts 54 to 90°.

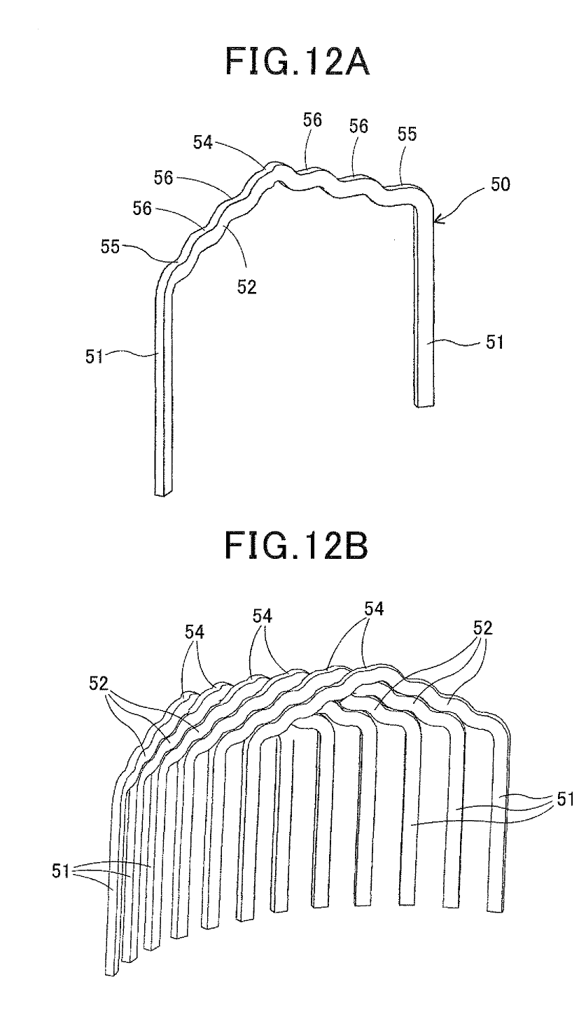

Referring now to FIGS. 12A-12B, after forming the stator coil 40 with the electric wires 50 and assembling the stator core 30 to the stator coil 40, each of the turn portions 52 (i.e., 52A-52K) of the electric wires 50 is offset by the crank-shaped part 54 formed therein in a radial direction of the stator core 30. In addition, though not shown in FIGS. 12A-12B, each of the crank-shaped parts 54 formed in the turn portions 52 of the electric wires 50 extends parallel to a corresponding axial end face 30a of the stator core 30.

Further, in the present embodiment, the amount of radial offset made by each of the crank-shaped parts 54 is set to be equal to the radial thickness of the in-slot portions 51 of the electric wires 50. Here, the amount of radial offset made by each of the crank-shaped parts 54 is defined as the difference in radial position between the opposite ends of the crank-shaped part 54. Accordingly, for each of the electric wires 50, the difference in radial position between each adjacent pair of the in-slot portions 51, which are connected by a corresponding one of the turn portions 52, is equal to the radial thickness (i.e., thickness in the radial direction of the stator core 30) of the in-slot portions 51.

Setting the amount of radial offset as above, it is possible to arrange each adjacent pair of the turn portions 52 of the electric wires 50 in intimate contact with each other, as shown in FIG. 12B. As a result, the radial thickness of the coil end parts 42a and 42b of the stator coil 40 can be minimized. In addition, it is also possible to make each adjacent pair of the turn portions 52 of the electric wires 50 extend in the circumferential direction of the stator core 30 without interference therebetween.

Moreover, as shown in FIGS. 12A-12B, each of the turn portions 52 of the electric wires 50 includes a pair of shoulder parts 55 which respectively adjoin the pair of the in-slot portions connected by the turn portion 52 and both extend perpendicular to the pair of the in-slot portions 51 (or parallel to the corresponding axial end face 30a of the stator core 30). Consequently, with the shoulder parts 55, the protruding height of each of the turn portions 52 from the corresponding axial end face 30a of the stator core 30 can be reduced. As a result, the axial length of the coil end parts 42a and 42b of the stator coil 40 can be reduced. In addition, the coil end parts 42a and 42b of the stator coil 40 are each comprised of those of the turn portions 52 of the electric wires 50 which are located on the same axial side of the stator core 30.

Further, in the present embodiment, there is specified the following dimensional relationship: d1<d2, where d1 is the length of each of the shoulder parts 55 of the electric wires 50 in the circumferential direction of the stator core 30 and d2 is the distance between each circumferentially-adjacent pair of the slots 31 of the stator core 30.

Specifying the above relationship, it is possible to prevent interference between each pair of the turn portions 52 of the electric wires 50 which respectively protrude from one circumferentially-adjacent pair of the slots 31 of the stator core 30. Consequently, it is possible to prevent both the axial length and radial thickness of the coil end parts 42a and 42b of the stator coil 40 from being increased for preventing the above-described interference.

Furthermore, as shown in FIGS. 12A-12B, each of the turn portions 52 of the electric wires 50 further includes two shoulder parts 56 between the crank-shaped part 54 and each of the shoulder parts 55. Accordingly, each of the turn portions 52 of the electric wires 50 includes one crank-shaped part 54, two shoulder parts 55, and four shoulder parts 56. Each of the shoulder parts 56 extends, like the shoulder parts 55, perpendicular to the in-slot portions 51 (or parallel to the corresponding axial end face 30a of the stator core 30). Consequently, with the shoulder parts 56, the protruding height of each of the turn portions 52 from the corresponding axial end face 30a of the stator core 30 can be further reduced. As a result, the axial length of the coil end parts 42a and 42b of the stator coil 40 can be further reduced.

In addition, each of the turn portions 52 of the electric wires 50 can be seen as being stepped on both sides of the crank-shaped part 54 to reduce its protruding height from the corresponding axial end face 30a of the stator core 30.

In the present embodiment, the stator coil 40 is formed with the 48 electric wires 50 as shown in FIGS. 11A-11B. It should be noted that the crossover parts 70 may be omitted from some of the electric wires 50 for facilitating the formation of the U-phase, V-phase and W-phase output terminals and the U-phase, V-phase and W-phase neutral terminals in the stator coil 40. However, in any case, it is preferable that all of the electric wires 50 have the same shape at least between the lead portions 53a and 53b.

In forming the stator coil 40, the 48 electric wires 50 are first stacked one by one so that the longitudinal directions Y of the electric wires 50 are parallel to each other and the first in-slot portions 51A of the electric wires 50 are offset from one another in the longitudinal directions Y by one slot pitch of the stator core 30 (i.e., the circumferential distance between the centers of each adjacent pair of the slots 31 of the stator core 30). Consequently, the band-shaped electric wire assembly 45 as shown in FIGS. 13A-13B is obtained. The assembly 45 has a pair of stepped surfaces 45a that are respectively formed at opposite longitudinal ends of the assembly 45 to face in opposite directions.

In addition, in FIG. 13A, the first electric wire 50 (to be denoted by 50a hereinafter) in the stacking of the electric wires 50 is located at the left end and the bottom of the electric wire assembly 45; the last electric wire 50 (to be denoted by 50b hereinafter) in the stacking of the electric wires 50 is located at the right end and the top of the assembly 45.

The band-shaped electric wire assembly 45 is then rolled to have the shape of a hollow cylinder with a constant radial thickness in the circumferential direction. More specifically, as shown in FIG. 13A, the band-shaped electric wire assembly 45 is rolled from the left end in the counterclockwise direction Z, bringing the two stepped surfaces 45a into complete contact with each other.

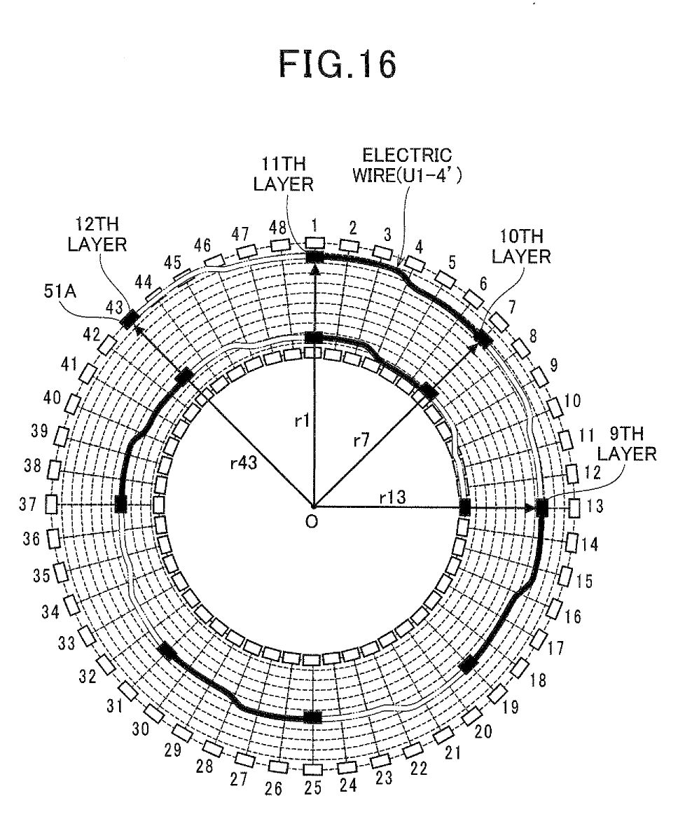

Consequently, as shown in FIG. 13C, each of the electric wires 50 included in the assembly 45 is rolled by about one and a half turns into a spiral shape. Accordingly, in the finally-obtained stator 20, when viewed along the longitudinal axis O of the stator core 30, each of the electric wires 50 spirally extends around the axis O of the stator core 30 (see FIG. 16).

Thereafter, corresponding pairs of the lead portions 53a and 53b of the electric wires 50 are joined together by, for example, welding. As a result, the stator coil 40 as shown in FIGS. 6-9 is obtained.

In the stator coil 40, those of the turn portions 52 of the electric wires 50 which are located most radially outward do not protrude radially outward from those of the in-slot portions 51 of the electric wires 50 which are located most radially outward in the slots 31 of the stator core 30. Consequently, the outside diameter of the coil end parts 42a and 42b of the stator coil 40 can be limited.

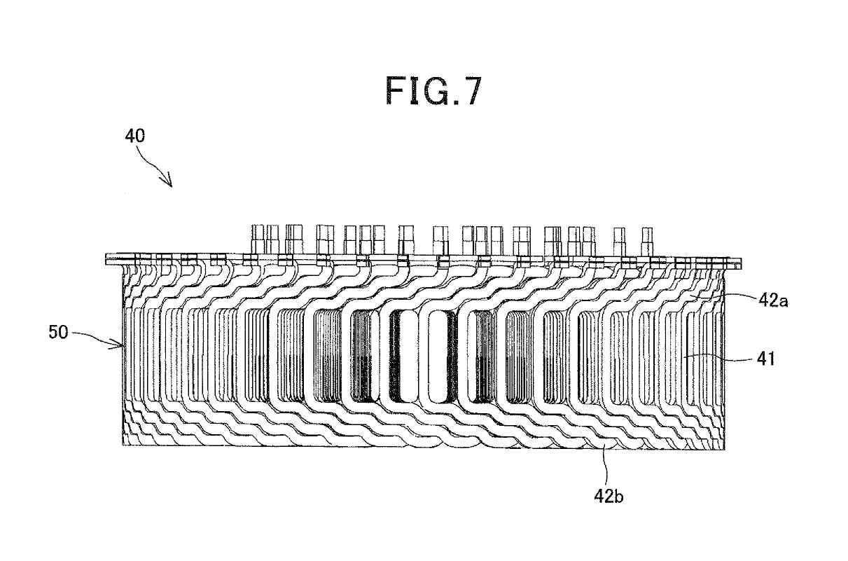

As described previously, each of the turn portions 52 of the electric wires 50 includes, substantially at the center thereof, the crank-shaped part 54 by which the turn potion 52 is radially offset by the radial thickness of the in-slot portions 51. Accordingly, for each of the electric wires 50, the difference in radial position between each adjacent pair of the in-slot portions 51, which are connected by a corresponding one of the turn portions 52, is equal to the radial thickness of the in-slot portions 51. Moreover, for each of the electric wires 50, the first in-slot portion 51A is located most radially outward while the twelfth in-slot portion 51L is located most radially inward; the predetermined pitches X between the in-slot portions 51A-51L gradually decrease in a direction from the first in-slot portion 51A to the twelfth in-slot portion 51L (see FIG. 11B). Consequently, those of the in-slot portions 51 of the electric wires 50 which are stacked in a radial direction of the stator coil 40 (or a radial direction of the stator core 30) can be aligned straight in the radial direction, thereby allowing the stator coil 40 to have a substantially perfect hollow-cylindrical shape as shown in FIGS. 6 and 7.

Furthermore, all of the ith in-slot portions 51 of the 48 electric wires 50 are located respectively in the 48 slots 31 of the stator core 30 at the same radial position, where i=1, 2, . . . , 12. For example, all of the first in-slot portions 51A of the 48 electric wires 50 are located respectively in the 48 slots 31 and positioned most radially outward in the respective slots 31; all of the twelfth in-slot portions 51L of the 48 electric wires 50 are located respectively in the 48 slots 31 and positioned most radially inward in the respective slots 31. With the above location of the in-slot portions 51 of the electric wires 50, both the outside and inside diameters of the stator coil 40 can be made uniform in the circumferential direction of the stator core 30.

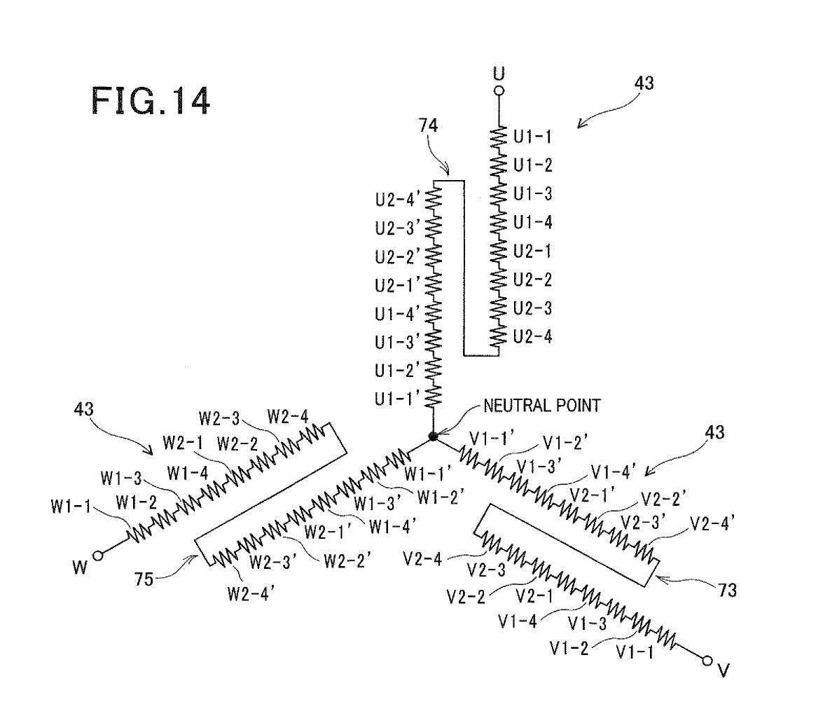

In the present embodiment, as shown in FIG. 14, the stator coil 40 is formed as a three-phase coil which is comprised of a U-phase winding 43U, a V-phase winding 43V and a W-phase winding 43W. Each of the phase windings 43U-43W is formed by serially connecting 16 electric wires 50. Further, the U-phase output and U-phase neutral terminals are respectively formed at the opposite ends of the U-phase winding 43U; the V-phase output and V-phase neutral terminals are respectively formed at the opposite ends of the V-phase winding 43V; and the W-phase output and W-phase neutral terminals are respectively formed at the opposite ends of the W-phase winding 43W. Furthermore, the phase windings 43U-43W are Y-connected to define a neutral point therebetween. That is, the U-phase, V-phase and W-phase neutral terminals of the U-phase, V-phase and W-phase windings 43U-43W are electrically connected together at the neutral point. Consequently, three-phase AC power is input to or output from the stator coil 40 via the U-phase, V-phase and W-phase output terminals.

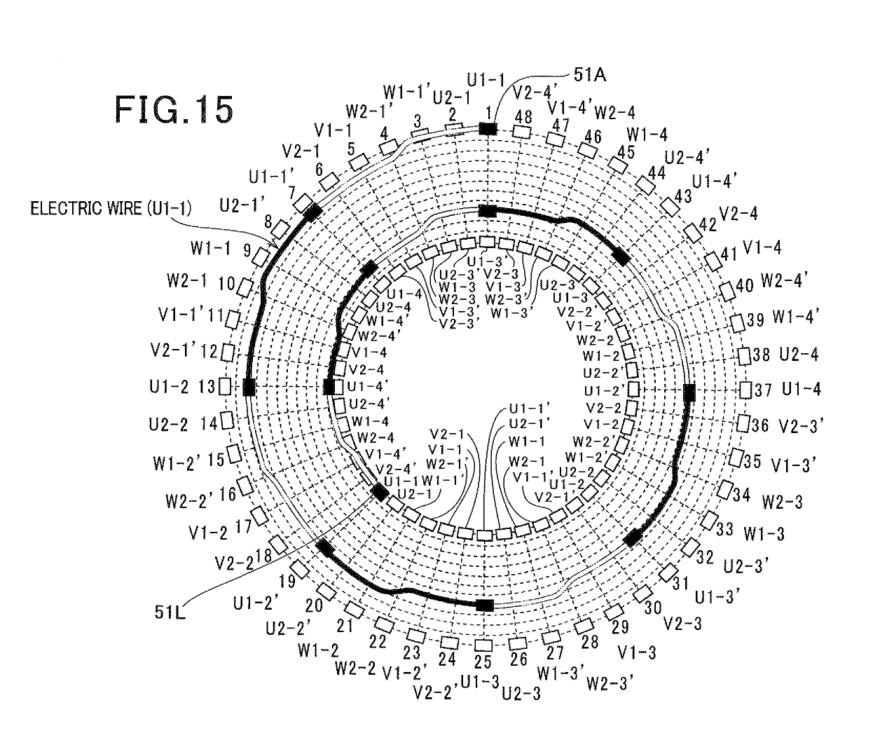

In FIGS. 15 and 16, the intersections between 12 dashed-line circles and 48 radially-extending dashed lines represent the positions of the in-slot portions 51 of the electric wires 50. In addition, among the positions of the in-slot portions 51, only the radially outermost and radially innermost ones are denoted by rectangles.

It can be seen from FIGS. 15 and 16 that in the present embodiment, in each of the slots 31 of the stator core 30, the in-slot portions 51 of the electric wires 50 are radially stacked in 12 layers.

Further, in FIGS. 15 and 16, the numbers 1-48 of the slots 31 of the stator core 30 are respectively shown radially outside of the 48 radially-extending dashed lines. In addition, in FIG. 15, each of the 48 electric wires 50 is labeled radially outside of the slot 31 in which the first in-slot portion 51A of the electric wire 50 is located most radially outward (i.e., located at the twelfth layer in the slot 31); each of the 48 electric wires 50 is also labeled radially inside of the slot 31 in which the twelfth in-slot portion 51L of the electric wire 50 is located most radially inward (i.e., located at the first layer in the slot 31).

In the present embodiment, each of the U-phase, V-phase and W-phase windings 43U-43W of the stator coil 40 is formed with first and second electric wire groups each consisting of eight electric wires 50. The in-slot portions 51 of the electric wires 50 of the first group are received in eight common slots 31 of the stator core 30. Similarly, the in-slot portions 51 of the electric wires 50 of the second group are also received in another eight common slots 31 of the stator core 30. That is, the in-slot portions 51 of the electric wires 50 of the first group are received in different slots 31 from the in-slot portions 51 of the electric wires 50 of the second group.

For example, the U-phase winding 43U is formed with a first electric wire group, which consists of the electric wires 50 labeled (U1-1) to (U1-4) and (U1-1′) to (U1-4′), and a second electric wire group that consists of the electric wires 50 labeled (U2-1) to (U2-4) and (U2-1′) to (U2-4′). The in-slot portions 51 of the (U1-1) to (U1-4) and (U1-1′) to (U1-4′) electric wires 50 are received in the Nos. 1, 7, 13, 19, 25, 31, 37 and 43 slots 31 of the stator core 30. On the other hand, the in-slot portions 51 of the (U2-1) to (U2-4) and (U2-1′) to (U2-4′) electric wires 50 are received in the Nos. 2, 8, 14, 20, 26, 32, 38 and 44 slots 31 of the stator core 30.

FIG. 15 illustrates, from one axial side of the stator core 30, the arrangement of each of the 48 electric wires 50 by taking the (U1-1) electric wire 50 as an example. Specifically, in FIG. 15, the positions of the in-slot portions 51 of the (U1-1) electric wire 50 are denoted by black rectangles; those of the turn portions 52 of the (U1-1) electric wire 50 which are located on the one axial side of the stator core 30 (i.e., on the front side of the paper surface of FIG. 15) are denoted by circumferentially-extending heavy lines; and those of the turn portions 52 of the (U1-1) electric wire 50 which are located on the other axial side of the stator core 30 (i.e., on the rear side of the paper surface of FIG. 15) are denoted by circumferentially-extending two-dot dashed lines. As seen from FIG. 15, for the (U1-1) electric wire 50, the first in-slot portion 51A is located at the twelfth layer (i.e., the radially outermost layer) in the No. 1 slot 31; the twelfth in-slot portion 51L is located at the first layer (i.e., the radially innermost layer) in the No. 19 slot 31; the first to the twelfth in-slot portions 51A-51L are circumferentially spaced at a six-slot pitch; and the radial positions of the in-slot portions 51A-51L are successively offset radially inward by one layer each time.

FIG. 16 illustrates, from the other axial side of the stator core 30, the arrangement of each of the 48 electric wires 50 by taking the (U1-4′) electric wire 50 as an example. Specifically, in FIG. 16, the positions of the in-slot portions 51 of the (U1-4′) electric wire 50 are denoted by black rectangles; those of the turn portions 52 of the (U1-4′) electric wire 50 which are located on the other axial side of the stator core 30 (i.e., on the front side of the paper surface of FIG. 16) are denoted by circumferentially-extending heavy lines; and those of the turn portions 52 of the (U1-4′) electric wire 50 which are located on the one axial side of the stator core 30 (i.e., on the rear side of the paper surface of FIG. 16) are denoted by circumferentially-extending two-dot dashed lines. As seen from FIG. 16, for the (U1-4′) electric wire 50, the first in-slot portion 51A is located at the twelfth layer in the No. 43 slot 31; the twelfth in-slot portion 51L is located at the first layer in the No. 13 slot 31; the first to the twelfth in-slot portions 51A-51L are circumferentially spaced at a six-slot pitch; and the radial positions of the in-slot portions 51A-51L are successively offset by one layer each time.

As described previously, in the present embodiment, the stator core 30 has the 48 slots 31 formed therein, while the stator coil 40 is formed with the 48 electric wires 50. The electric wires 50 are mounted on the stator core 30 so that they are offset from one another in the circumferential direction of the stator core 30 by one slot pitch of the stator core 30. Consequently, the first in-slot portions 51A of the 48 electric wires 50 are respectively located at the radially outermost layers (i.e., the twelfth layers) in the 48 slots 31; the twelfth in-slot portions 51L of the 48 electric wires 50 are respectively located at the radially innermost layers (i.e., the first layers) in the 48 slots 31.

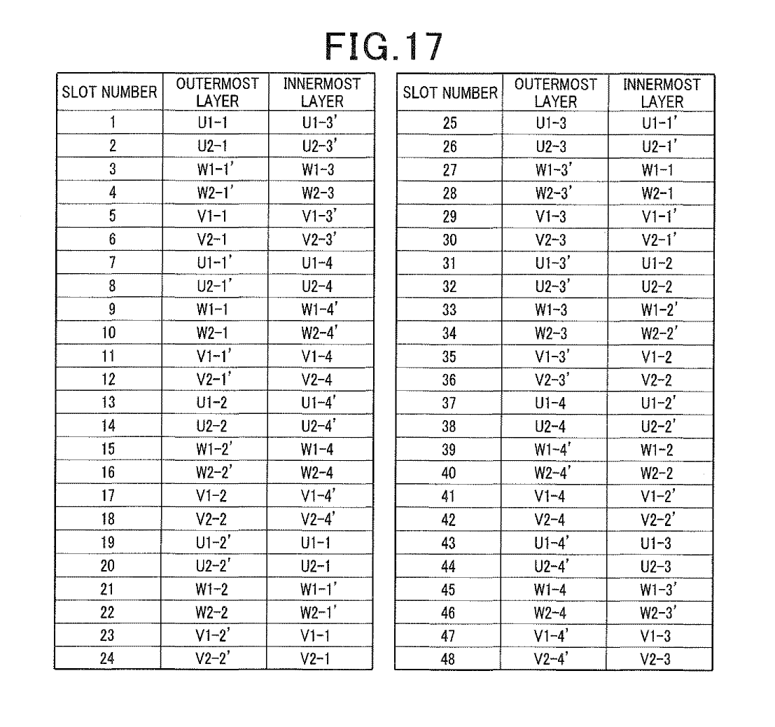

FIG. 17 lists both the label of the electric wire 50 located at the radially outermost layer and the label of the electric wire 50 located at the radially innermost layer in each of the slots 31 of the stator core 30.

In the present embodiment, for each of the 48 electric wires 50 forming the stator coil 40, the radial distances from the axis O of the stator core 30 to the in-slot portions 51 of the electric wire 50 successively decrease in the sequence from the first in-slot portion 51A to the twelfth in-slot portion 51L. Moreover, for each of the 48 electric wires 50, the difference in radial distance from the axis O of the stator core 30 between each adjacent pair of the in-slot portions 51, which are connected by a corresponding one of the turn portions 52, is equal to the radial thickness of the in-slot portions 51.

For example, referring back to FIG. 16, for the (U1-4′) electric wire 50, there is satisfied the following relationship: r43>r1>r7>r13. Here, r43 represents the radial distance from the axis O of the stator core 30 to the first in-slot portion 51A that is located at the twelfth layer in the No. 43 slot 31; r1 represents the radial distance from the axis O to the second in-slot portion 51B that is located at the eleventh layer in the No. 1 slot 31; r7 represents the radial distance from the axis O to the third in-slot portion 51C that is located at the tenth layer in the No. 7 slot 31; and r13 represents the radial distance from the axis O to the fourth in-slot portion 51D that is located at the ninth layer in the No. 13 slot 31. Further, the radial distances r43, r1, r7 and r13 successively decrease in decrements of the radial thickness of the in-slot portions 51.

Next, with reference to FIGS. 14 and 17-18, the manner of serially connecting the 16 electric wires 50 for forming the V-phase winding 43V of the stator coil 40 will be described. In addition, it should be noted that the electric wires 50 for forming the U-phase and W-phase windings 43U and 43W of the stator coil 40 are also connected in the same manner as those for forming the V-phase winding 43V.

As shown in FIG. 14, the V-phase winding 43V is formed by serially connecting the (V1-1) to (V1-4), (V1-1′) to (V1-V41, (V2-1) to (V2-4), and (V2-1′) to (V2-4′) electric wires 50.

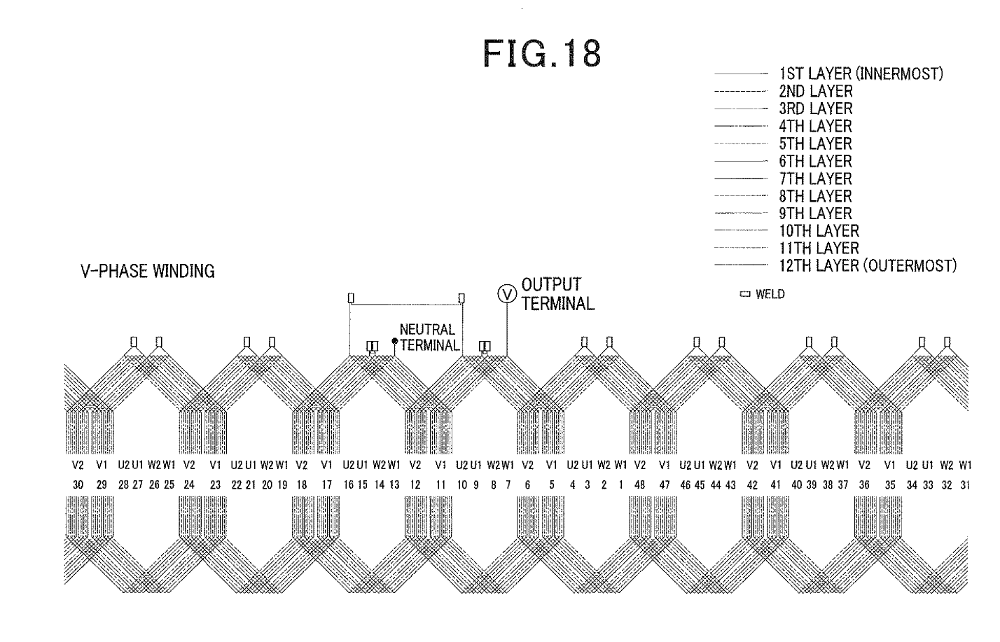

Specifically, to the V-phase output terminal, there is connected the first in-slot portion 51A-side end of the (V1-1) electric wire 50. Moreover, as shown in FIGS. 17 and 18, for the (V1-1) electric wire 50, the first in-slot portion 51A is located at the radially outermost layer (i.e., the twelfth layer) in the No. 5 slot 31 of the stator core 30, while the twelfth in-slot portion 51L is located at the radially innermost layer (i.e., the first layer) in the No. 23 slot 31.

To the twelfth in-slot portion 51L-side end of the (V1-1) electric wire 50, there is connected the first in-slot portion 51A-side end of the (V1-2) electric wire 50. Moreover, for the (V1-2) electric wire 50, the first in-slot portion 51A is located at the radially outermost layer in the No. 17 slot 31, while the twelfth in-slot portion 51L is located at the radially innermost layer in the No. 35 slot 31.

To the twelfth in-slot portion 51L-side end of the (V1-2) electric wire 50, there is connected the first in-slot portion 51A-side end of the (V1-3) electric wire 50. Moreover, for the (V1-3) electric wire 50, the first in-slot portion 51A is located at the radially outermost layer in the No. 29 slot 31, while the twelfth in-slot portion 51L is located at the radially innermost layer in the No. 47 slot 31.

To the twelfth in-slot portion 51L-side end of the (V1-3) electric wire 50, there is connected the first in-slot portion 51A-side end of the (V1-4) electric wire 50. Moreover, for the (V1-4) electric wire 50, the first in-slot portion 51A is located at the radially outermost layer in the No. 41 slot 31, while the twelfth in-slot portion 51L is located at the radially innermost layer in the No. 11 slot 31.

To the twelfth in-slot portion 51L-side end of the (V 1-4) electric wire 50, there is connected the first in-slot portion 51A-side end of the (V2-1) electric wire 50. Moreover, for the (V2-1) electric wire 50, the first in-slot portion 51A is located at the radially outermost layer in the No. 6 slot 31, while the twelfth in-slot portion 51L is located at the radially innermost layer in the No. 24 slot 31.

To the twelfth in-slot portion 51L-side end of the (V2-1) electric wire 50, there is connected the first in-slot portion 51A-side end of the (V2-2) electric wire 50. Moreover, for the (V2-2) electric wire 50, the first in-slot portion 51A is located at the radially outermost layer in the No. 18 slot 31, while the twelfth in-slot portion 51L is located at the radially innermost layer in the No. 36 slot 31.

To the twelfth in-slot portion 51L-side end of the (V2-2) electric wire 50, there is connected the first in-slot portion 51A-side end of the (V2-3) electric wire 50. Moreover, for the (V2-3) electric wire 50, the first in-slot portion 51A is located at the radially outermost layer in the No. 30 slot 31, while the twelfth in-slot portion 51L is located at the radially innermost layer in the No. 48 slot 31.

To the twelfth in-slot portion 51L-side end of the (V2-3) electric wire 50, there is connected the first in-slot portion 51A-side end of the (V2-4) electric wire 50. Moreover, for the (V2-4) electric wire 50, the first in-slot portion 51A is located at the radially outermost layer in the No. 42 slot 31, while the twelfth in-slot portion 51L is located at the radially innermost layer in the No. 12 slot 31.

To the twelfth in-slot portion 51L-side end of the (V2-4) electric wire 50, there is connected the twelfth in-slot portion 51L-side end of the (V2-4′) electric wire 50. Moreover, for the (V2-4′) electric wire 50, the first in-slot portion 51A is located at the radially outermost layer in the No. 48 slot 31, while the twelfth in-slot portion 51L is located at the radially innermost layer in the No. 18 slot 31.

To the first in-slot portion 51A-side end of the (V2-4′) electric wire 50, there is connected the twelfth in-slot portion 51L-side end of the (V2-3′) electric wire 50. Moreover, for the (V2-3′) electric wire 50, the first in-slot portion 51A is located at the radially outermost layer in the No. 36 slot 31, while the twelfth in-slot portion 51L is located at the radially innermost layer in the No. 6 slot 31.

To the first in-slot portion 51A-side end of the (V2-3′) electric wire 50, there is connected the twelfth in-slot portion 51L-side end of the (V2-2′) electric wire 50. Moreover, for the (V2-2′) electric wire 50, the first in-slot portion 51A is located at the radially outermost layer in the No. 24 slot 31, while the twelfth in-slot portion 51L is located at the radially innermost layer in the No. 42 slot 31.

To the first in-slot portion 51A-side end of the (V2-2′) electric wire 50, there is connected the twelfth in-slot portion 51L-side end of the (V2-1′) electric wire 50. Moreover, for the (V2-1′) electric wire 50, the first in-slot portion 51A is located at the radially outermost layer in the No. 12 slot 31, while the twelfth in-slot portion 51L is located at the radially innermost layer in the No. 30 slot 31.

To the first in-slot portion 51A-side end of the (V2-1′) electric wire 50, there is connected the twelfth in-slot portion 51L-side end of the (V1-4′) electric wire 50. Moreover, for the (V1-4′) electric wire 50, the first in-slot portion 51A is located at the radially outermost layer in the No. 47 slot 31, while the twelfth in-slot portion 51L is located at the radially innermost layer in the No. 17 slot 31.

To the first in-slot portion 51A-side end of the (V1-4′) electric wire 50, there is connected the twelfth in-slot portion 51L-side end of the (V1-3′) electric wire 50. Moreover, for the (V1-3′) electric wire 50, the first in-slot portion 51A is located at the radially outermost layer in the No. 35 slot 31, while the twelfth in-slot portion 51L is located at the radially innermost layer in the No. 5 slot 31.

To the first in-slot portion 51A-side end of the (V1-3′) electric wire 50, there is connected the twelfth in-slot portion 51U-side end of the (V1-2′) electric wire 50. Moreover, for the (V1-2′) electric wire 50, the first in-slot portion 51A is located at the radially outermost layer in the No. 23 slot 31, while the twelfth in-slot portion 51L is located at the radially innermost layer in the No. 41 slot 31.

To the first in-slot portion 51A-side end of the (V1-2′) electric wire 50, there is connected the twelfth in-slot portion 51L-side end of the (V1-1′) electric wire 50. Moreover, for the (V1-1′) electric wire 50, the first in-slot portion 51A is located at the radially outermost layer in the No. 11 slot 31, while the twelfth in-slot portion 51L is located at the radially innermost layer in the No. 29 slot 31. In addition, the first in-slot portion 51A-side end of the (V1-1′) electric wire 50 makes up the V-phase neutral terminal of the stator coil 40.

Further, as described previously, each of the electric wires 50 has the lead portion 53a formed at the first in-slot portion 51A-side end thereof and the lead portion 53b formed at the twelfth in-slot portion 51L-side end thereof (see FIGS. 11A-11B). The lead portion 53a is connected to the first in-slot portion 51A via the half-turn portion 52M, and the lead portion 53b is connected to the twelfth in-slot portion 51L via the half-turn portion 52N. The lead portion 53b also has the crossover part 70 formed therein. In the present embodiment, the connection between the electric wires 50 is made by welding corresponding pairs of the lead portions 53a and 53b of the electric wires 50.

For example, the (V1-1) electric wire 50 has the first in-slot portion 51A located at the radially outermost layer in the No. 5 slot 31 of the stator core 30 and the twelfth in-slot portion 51L located at the radially innermost layer in the No. 23 slot 31. The lead portion 53b of the (V1-1) electric wire 50 is offset, by the length of the half-turn portion 52N in the circumferential direction of the stator core 30, from the No. 23 slot 31 to the vicinity of the No. 20 slot 31. On the other hand, the (V1-2) electric wire 50 has the first in-slot portion 51A located at the radially outermost layer in the No. 17 slot 31 and the twelfth in-slot portion 51L located at the radially innermost layer in the No. 35 slot 31. The lead portion 53a of the (V 1-2) electric wire 50 is offset, by the length of the half-turn portion 52M in the circumferential direction of the stator core 30, from the No. 17 slot 31 to the vicinity of the No. 20 slot 31. Further, as shown in FIGS. 6-9, the lead portion 53b of the (V1-1) electric wire 50 is bent radially outward substantially at a right angle to extend from the radially inner periphery of the stator coil 40 to the lead portion 53a of the (V1-2) electric wire 50 which is located on the radially outer periphery of the stator coil 40; then, the lead portion 53b of the (V1-1) electric wire 50 is welded to the lead portion 53a of the (V1-2) electric wire 50. In other words, the twelfth in-slot portion 51L-side end of the (V1-1) electric wire 50 is joined to the first in-slot portion 51A-side end of the (V1-2) electric wire 50 by welding.

Moreover, in the present embodiment, all of the corresponding pairs of the lead portions 53a and 53b of the electric wires 50 are welded radially outside of the radially outermost turn portions 52 of the electric wires 50. To this end, each of the lead portions 53b of the electric wires 50 is configured to include the crossover part 70 that crosses over the annular axial end face of the stator coil 40 (more specifically, the annular axial end face of the coil end part 42a of the stator coil 40 which is comprised of the turn portions 52 of the electric wires 50) from the radially inside to the radially outside of the axial end face. Consequently, it is possible to reliably prevent the twelfth in-slot portions 51L of the electric wires 50, which are located most radially inward in the slots 31 of the stator core 30, from protruding radially inward. As a result, it is possible to reliably prevent the stator coil 40 from interfering with the rotor of the electric rotating machine which is located radially inside of the stator 20.

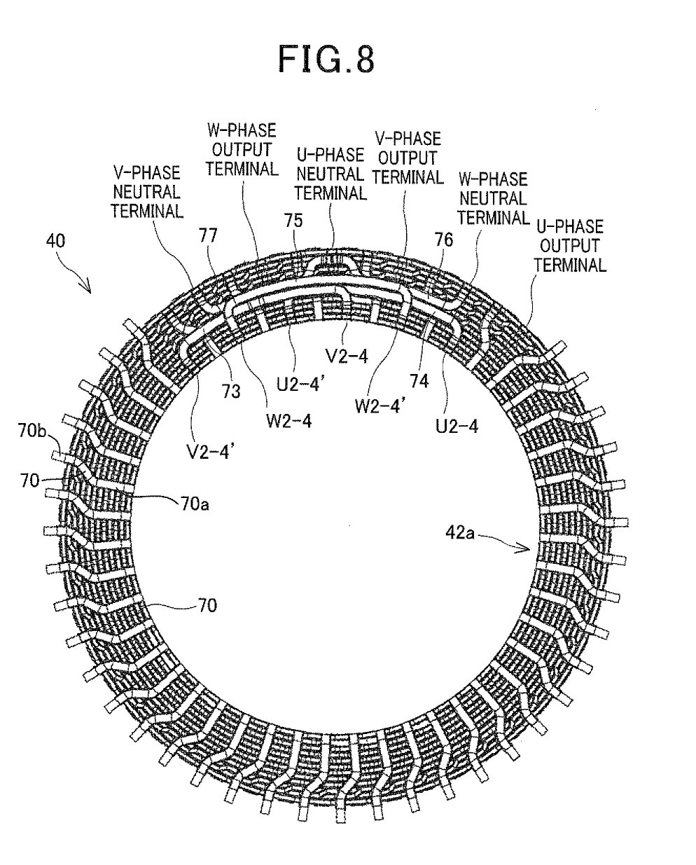

Furthermore, in the present embodiment, as shown in FIG. 8, each of the crossover parts 70 of the electric wires 50 is crank-shaped to include a pair of radially-extending end sections 70a and 70b. With such a shape, it is possible to facilitate the bending of the lead portions 53b of the electric wires 50 for forming the crossover parts 70 and the welding of the corresponding pairs of the lead portions 53a and 53b of the electric wires 50.

In addition, as shown in FIGS. 6 and 8, on the annular axial end face of the stator coil 40, the crossover parts 70 occupy substantially ¾ of the full angular range of the axial end face; the full angular range is 360°. Further, within the remaining ¼ of the full angular range, there are sequentially arranged the V-phase neutral terminal, the W-phase output terminal, the U-phase neutral terminal, the V-phase output terminal, the W-phase neutral terminal and the U-phase output terminal of the stator coil 40. That is, on the axial end face of the stator coil 40, the U-phase, V-phase and W-phase output terminals are arranged in the same angular range as the U-phase, V-phase and W-phase neutral terminals; the crossover parts 70 are arranged in a different angular range from the U-phase, V-phase and W-phase output terminals and the U-phase, V-phase and W-phase neutral terminals.

The stator core 30 is assembled to the above-described stator coil 40 by inserting the tooth portions 33 of the stator core segments 32 into the spaces formed between the stacks of the in-slot portions 51 of the electric wires 50 from the radially outside of the stator coil 40. Consequently, each of the in-slot portions 51 of the electric wires 50 forming the stator coil 40 is received in a corresponding one of the slots 31 of the stator core 30. More specifically, for each of the electric wires 50, each adjacent pair of the in-slot portions 51 are respectively received in a corresponding pair of the slots 31 of the stator core 30 which are circumferentially spaced at a six-slot pitch. Moreover, each of the turn portions 52, which connects a corresponding pair of the in-slot portions 51, protrudes from a corresponding one of the axial end faces of the stator core 30.

Furthermore, referring back to FIG. 14, in the present embodiment, each of the U-phase, V-phase and W-phase windings 43U-43W of the stator coil 40 is comprised of first and second electric wire sets; each of the first and second electric wire sets consists of a predetermined number of (e.g., 8 in the present embodiment) the electric wires 50 which are electrically connected in series with one another. Moreover, the stator coil 40 further includes first to fifth bridging wires 73-77 each of which electrically connects (or bridges) a corresponding pair of the electric wire sets that form the phase windings 43U-43W of the stator coil 40.

Specifically, for the V-phase winding 43V, as shown in FIG. 14, the first electric wire set consists of the (V1-1), (V1-2), (V1-3), (V1-4), (V2-1), (V2-2), (V2-3) and (V2-4) electric wires 50 that are electrically connected in series with one another. The second electric wire set consists of the (V2-4′), (V2-3′), (V2-2′), (V2-1′), (V1-4′), (V1-3′), (V1-2′) and (V1-1′) electric wires 50 that are electrically connected in series with one another. The first bridging wire 73 electrically connects the first and second electric wire sets, more specifically electrically connects the twelfth in-slot portion 51L-side end of the (V2-4) electric wire 50 of the first electric wire set to the twelfth in-slot portion 51L-side end of the (V2-4′) electric wire 50 of the second electric wire set (see also FIG. 8). In addition, the first in-slot portion 51A-side end of the (V1-1) electric wire 50 of the first electric wire set is electrically connected to the V-phase output terminal; the first in-slot portion 51A-side end of the (V1-1′) electric wire 50 of the second electric wire set makes up the V-phase neutral terminal.

For the U-phase winding 43U, as shown in FIG. 14, the first electric wire set consists of the (U1-1), (U1-2), (U1-3), (U1-4), (U2-1), (U2-2), (U2-3) and (U2-4) electric wires 50 that are electrically connected in series with one another. The second electric wire set consists of the (U2-4′), (U2-3′), (U2-2′), (U2-11 (U1-4′), (U1-3′), (U1-2′) and (U1-1′) electric wires 50 that are electrically connected in series with one another. The second bridging wire 74 electrically connects the first and second electric wire sets, more specifically electrically connects the twelfth in-slot portion 51L-side end of the (U2-4) electric wire 50 of the first electric wire set to the twelfth in-slot portion 51L-side end of the (U2-4′) electric wire 50 of the second electric wire set (see also FIG. 8). In addition, the first in-slot portion 51A-side end of the (U1-1) electric wire 50 of the first electric wire set is electrically connected to the U-phase output terminal; the first in-slot portion 51A-side end of the (U1-1′) electric wire 50 of the second electric wire set makes up the U-phase neutral terminal.

For the W-phase winding 43W, as shown in FIG. 14, the first electric wire set consists of the (W1-1), (W1-2), (W1-3), (W1-4), (W2-1), (W2-2), (W2-3) and (W2-4) electric wires 50 that are electrically connected in series with one another. The second electric wire set consists of the (W2-4′), (W2-3′), (W2-2′), (W2-1′), (W1-4′), (W1-3′), (W1-2′) and (W1-1′) electric wires 50 that are electrically connected in series with one another. The third bridging wire 75 electrically connects the first and second electric wire sets, more specifically electrically connects the twelfth in-slot portion 51L-side end of the (W2-4) electric wire 50 of the first electric wire set to the twelfth in-slot portion 51L-side end of the (W2-4′) electric wire 50 of the second electric wire set (see also FIG. 8). In addition, the first in-slot portion 51A-side end of the (W1-1) electric wire 50 of the first electric wire set is electrically connected to the W-phase output terminal; the first in-slot portion 51A-side end of the (W1-1′) electric wire 50 of the second electric wire set makes up the W-phase neutral terminal.

Moreover, as shown in FIG. 8, the fourth bridging wire 76 electrically connects the U-phase neutral terminal to the W-phase neutral terminal; the fifth bridging wire 77 electrically connects the U-phase neutral terminal to the V-phase neutral terminal. That is, though not shown in FIG. 14, the fourth bridging wire 76 electrically connects the second electric wire sets of the U-phase and W-phase windings 43U and 43W; the fifth bridging wire 76 electrically connects the second electric wire sets of the U-phase and V-phase windings 43U and 43V.

Referring now to FIGS. 8, 19A-19B and 20, in the present embodiment, the first to the fifth bridging wires 73-77 are arranged on the axial end face of the coil end part 42a of the stator coil 40. Each of the first to the fifth bridging wires 73-77 has a main portion that extends in the circumferential direction of the stator core 30 and a pair of end portions that are respectively formed at opposite ends of the main portion so as to extend substantially perpendicular to the main portion. Moreover, the first to the fifth bridging wires 73-77 have the same configuration as the electric wires 50 (see FIGS. 10A and 10B). That is, each of the first to the fifth bridging wires 73-77 is configured with, at least, an electric conductor 67 having a substantially rectangular cross section and an insulating coat 68 that covers the outer surface of the electric conductor. Furthermore, for each of the first to the fifth bridging wires 73-77, the main portion of the bridging wire partially overlaps at least one of the main portions of the other bridging wires; the overlapping parts of the main portions of the first to the fifth bridging wires 73-77 are fixed together by a fixing material 80.

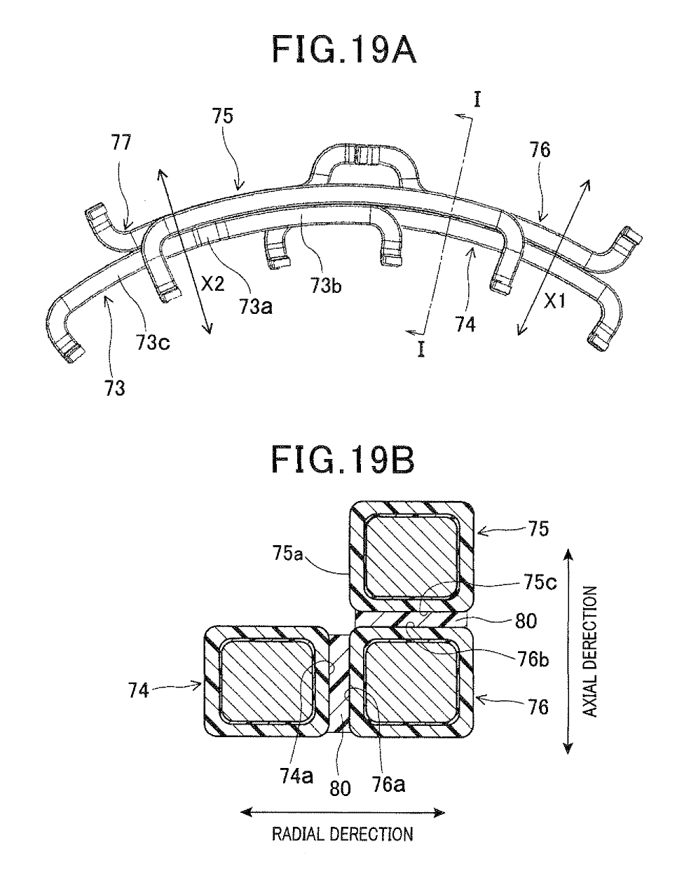

Specifically, as shown in FIG. 19A, the main portion of the first bridging wire 73 includes a step part 73a formed at the center thereof, an axially-outer part 73b that is positioned on one circumferential side (i.e., the right side in FIG. 19A) of the step part 73a, and an axially-inner part 73c that is positioned on the other circumferential side (i.e., the left side in FIG. 19A) of the step part 73a and axially inside the axially-outer part 73b. Moreover, the axially-inner part 73c is located at the same axial position as the main portion of the second bridging wire 74 so as to fall on a circumferential extension line of the main portion of the second bridging wire 74. The axially-outer part 73b is located axially outside the main portion of the second bridging wire 74 so as to partially overlap an end part of the main portion of the second bridging wire 74 in the axial direction of the stator core 30 (i.e., in the direction perpendicular to the paper surface of FIG. 19A). The overlapping parts of the main portions of the first and second bridging wires 73 and 74 are fixed together by the fixing material 80.

The main portion of the fourth bridging wire 76 is located at the same axial position as the main portion of the fifth bridging wire 77 so as to fall on a circumferential extension line of the main portion of the fifth bridging wire 77. Moreover, the main portions of the fourth and fifth bridging wires 76b and 77 are located radially outside the main portions of the first and second bridging wires 73 and 74. Furthermore, the entire main portion of the fourth bridging wire 76 overlaps part of the main portion of the second bridging wire 74 in the radial direction of the stator core 30 (i.e., the direction X1 in FIG. 19A). The main portion of the fifth bridging wire 77 partially overlaps the axially-inner part 73c of the main portion of the first bridging wire 73 in the radial direction of the stator core 30 (i.e., the direction X2 in FIG. 19A).

The main portion of the third bridging wire 75 is located on the axially outside (i.e., on the front side of the paper surface of FIG. 19A) of both the main portions of the fourth and fifth bridging wires 76 and 77. Moreover, the main portion of the third bridging wire 75 partially overlaps each of the main portions of the fourth and fifth bridging wires 76 and 77 in the axial direction of the stator core 30. Furthermore, part of the main portion of the third bridging wire 75 overlaps the entire axially-outer part 73b of the first bridging wire 73 in the radial direction of the stator core 30.

In the present embodiment, the first to the fifth bridging wires 73-77 are fixed to one another by the fixing material 80 at those places where pairs of the main portions of the bridging wires 73-77 overlap each other either in the axial direction or in the radial direction of the stator core 30.

For example, as shown in FIG. 19B, the main portion of the second bridging wire 74 partially overlaps the main portion of the fourth bridging wire 76 in the radial direction of the stator core 30, so that a flat side surface 74a of the second bridging wire 74 faces a flat side surface 76a of the fourth bridging wire 76 in the radial direction. The fixing material 80 is applied between the radially-facing pair of the side surfaces 74a and 76a, thereby fixing them together so as to keep them parallel to each other. Moreover, the main portion of the third bridging wire 75 partially overlaps the main portion of the fourth bridging wire 76 in the axial direction of the stator core 30, so that a flat side surface 75c of the third bridging wire 75 faces a flat side surface 76b of the fourth bridging wire 76 in the axial direction. The fixing material 80 is also applied between the axially-facing pair of the side surfaces 75c and 76b, thereby fixing them together so as to keep them parallel to each other.

In addition, the side surfaces 75c and 76b of the third and fourth bridging wires 75 and 76 have a larger width than the side surfaces 75a and 76a of the same which are respectively perpendicular to the side surfaces 75c and 76b. Consequently, by applying the fixing material 80 between the wider side surfaces 75c and 76b, it is possible to secure a higher fixing strength between the third and fourth bridging wires 75 and 76 in comparison with the case of applying the fixing material 80 between the narrower side surfaces 75a and 76a. Similarly, the axially-outer part 73b of the main portion of the first bridging wire 73 and the end part of the main portion of the second bridging wire 74, which overlap each other in the axial direction of the stator core 30, are fixed together by applying the fixing material 80 between an axially-facing pair of wider side surfaces thereof, thereby securing a higher fixing strength between the bridging wires 73 and 74. The main portions of the third and fifth bridging wires 75 and 77, which partially overlap each other in the axial direction of the stator core 30, are fixed together by applying the fixing material 80 between an axially-facing pair of wider side surfaces thereof, thereby securing a higher fixing strength between the bridging wires 75 and 77.

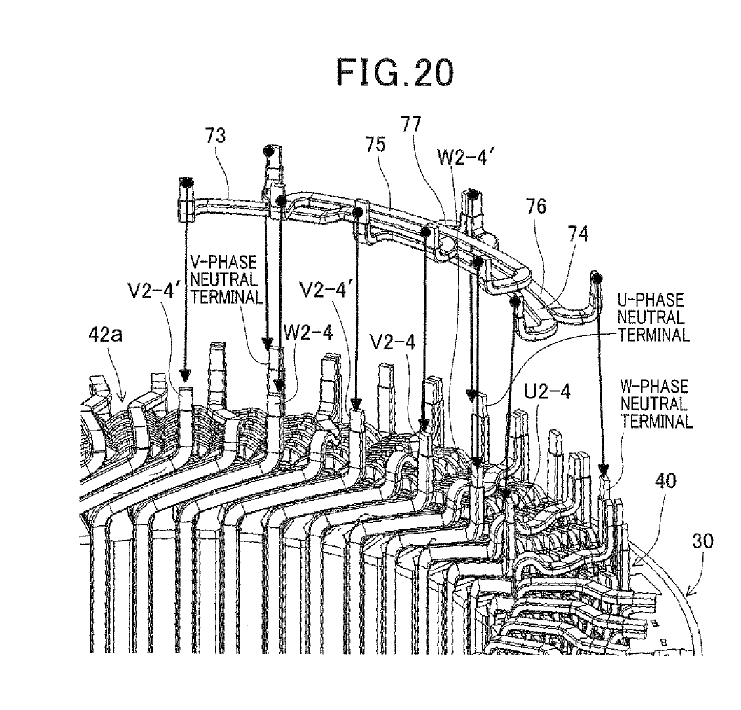

As shown in FIG. 20, the end portions of the first to the fifth bridging wires 73-77 are respectively welded to corresponding ends of the electric wires 50 which are positioned on either the radially inner or the radially outer periphery of the coil end part 42a of the stator coil 40. Specifically, the end portions of the first bridging wire 73 are respectively welded to the twelfth in-slot portion 51L-side ends of the (V2-4′) and (V2-4) electric wires 50 which are positioned on the radially inner periphery of the coil end part 42a of the stator coil 40. The end portions of the second bridging wire 74 are respectively welded to the twelfth in-slot portion 51L-side ends of the (U2-4′) and (U2-4) electric wires 50 which are positioned on the radially inner periphery of the coil end part 42a. The end portions of the third bridging wire 75 are respectively welded to the twelfth in-slot portion 51L-side ends of the (W2-4) and (W2-4′) electric wires 50 which are positioned on the radially inner periphery of the coil end part 42a. The end portions of the fourth bridging wire 76 are respectively welded to the U-phase and W-phase neutral terminals. The end portions of the fifth bridging wire 77 are respectively welded to the V-phase and U-phase neutral terminals. The U-phase, V-phase and W-phase neutral terminals are respectively made up of the first in-slot portion 51A-side ends of the (U1-1′), (V1-1′) and (W1-1′) electric wires 50, all of which are positioned on the radially outer periphery of the coil end part 42a of the stator coil 40. In addition, the welding of the end portions of the first to the fifth bridging wires 73-77 to the corresponding ends of the electric wires 50 is performed in the same stage as the welding of the corresponding pairs of the lead portions 53a and 53b of the electric wires 50.

After welding the end portions of the first to the fifth bridging wires 73-77 to the corresponding ends of the electric wires 50, the fixing material 80 is applied between the overlapping parts of the main portions of the first to the fifth bridging wires 73-77. More specifically, in the present embodiment, a thermosetting epoxy resin, which is initially in the form of powder, is employed as the fixing material 80. The epoxy resin is first injected into the spaces between the overlapping parts of the main portions of the first to the fifth bridging wires 73-77, and then heated and thereby cured. As a result, all of the bridging wires 73-77 are fixed to one another by the epoxy resin (i.e., the fixing material 80).

The above-described stator 20 according to the present embodiment has the following advantages.

In the present embodiment, each of the U-phase, V-phase and W-phase windings 43U-43W of the stator coil 40 is comprised of the first and second electric wire sets; each of the first and second electric wire sets consists of a predetermined number of (e.g., 8 in the present embodiment) the electric wires 50 which are electrically connected in series with one another. In other words, in the present embodiment, all the 48 electric wires 50 forming the stator coil 40 are grouped into six electric wire sets; each of the electric wire sets consists of eight electric wires 50 that are electrically connected in series with one another. Moreover, in the present embodiment, the stator coil 40 further includes the first to the fifth bridging wires 73-77; each of the bridging wires 73-77 extends, on the axially outer periphery of the coil end part 42a of the stator coil 40, to electrically connect a corresponding pair of the electric wire sets that form the phase windings 43U-43W of the stator coil 40. Furthermore, in the present embodiment, the first to the fifth bridging wires 73-77 are fixed to one another.

With the above configuration, during operation of the electric rotating machine, it is possible to effectively suppress displacement of the first to the fifth bridging wires 73-77 due to vibration of the stator 20. Consequently, it is possible to reliably prevent adjacent pairs of the bridging wires 73-77 from colliding or sliding against each other, thereby ensuring high insulation properties of the stator coil 40.

In the present embodiment, the first to the fifth bridging wires 73-77 are fixed to one another by the fixing material 80 provided between the overlapping parts of the bridging wires 73-77.

Consequently, the bridging wires 73-77 are mechanically joined to one another by the fixing material 80, thereby making it possible to reliably prevent the adjacent pairs of the bridging wires 73-77 from colliding or sliding against each other.

Further, in the present embodiment, the fixing material 80 is implemented by a resin.

Consequently, it is possible to easily apply the fixing material between the overlapping parts of the bridging wires 73-77 by first injecting powder of the resin into the spaces between the overlapping parts of the bridging wires 73-77 and then heating and thereby curing the resin.

Furthermore, in the present embodiment, the fixing material 80 is implemented by a thermosetting resin.

Consequently, when the ambient temperature becomes high or the temperature of the bridging wires 73-77 is increased by energization of the stator coil 40, it is still possible to secure a high fixing strength between the bridging wires 73-77.

In the present embodiment, each of the first to the fifth bridging wires 73-77 is comprised of the electric conductor 67 and the insulating coat 68 that covers the outer surface of the electric conductor 67.

Consequently, with the insulating coats 68, it is possible to reduce the vibrational load between each adjacent pair of the bridging wires 73-77 during operation of the electric rotating machine.

In the present embodiment, each of the first to the fifth bridging wires 73-77 has a substantially rectangular cross section perpendicular to the longitudinal direction of the bridging wire. For each fixed-together pair of the bridging wires 73-77, a facing pair of side surfaces of the bridging wires are fixed to each other by the fixing material 80.

With the above configuration, it is possible to secure a sufficiently large fixing area between each fixed-together pair of the bridging wires 73-77, thereby securing a high fixing strength between the bridging wires 73-77.

Further, in the present embodiment, for each fixed-together pair of the bridging wires 73-77, the fixing material 80 is applied so as to keep the facing pair of the side surfaces of the bridging wires parallel to each other.

Consequently, the thickness of the fixing material 80 can be made even between the facing pair of the side surfaces. As a result, when the ambient temperature is changed, it is possible to smooth the distribution of temperature in the fixing material 80, thereby preventing the fixing material 80 from being damaged by a large temperature gradient therein.

Furthermore, in the present embodiment, each of the first to the fifth bridging wires 73-77 has a pair of wider side surfaces and a pair of narrower side surfaces; the wider side surfaces have a larger width than the narrower side surfaces. For each of the fixed-together pairs of the first and second bridging wires 73 and 74, the third and fourth bridging wires 75 and 76, and the third and fifth bridging wires 75 and 77, a facing pair of the wider side surfaces of the bridging wires are fixed to each other by the fixing material 80.

With the above configuration, it is possible to maximize the fixing area between each of those fixed-together pairs of the bridging wires, thereby maximizing the fixing strength therebetween.

In the present embodiment, the stator core 30 is comprised of the stator core segments 32 that are fixed together so as to adjoin one another in the circumferential direction of the stator core 30.

With the above configuration of the stator core 30, during operation of the electric rotating machine, it is easier for the first to the fifth bridging wires 73-77 to be displaced in comparison with the case of employing a stator core that is formed in one piece. However, by fixing the bridging wires 73-77 to one anther according to the present embodiment, it is still possible to effectively suppress displacement of the first to the fifth bridging wires 73-77 due to vibration of the stator 20.

### Second Embodiment

In this embodiment, the first to the fifth bridging wires 73-77 are fixed to one another by pressure-joining (i.e., pressing and thereby joining together) the overlapping parts of the bridging wires 73-77.

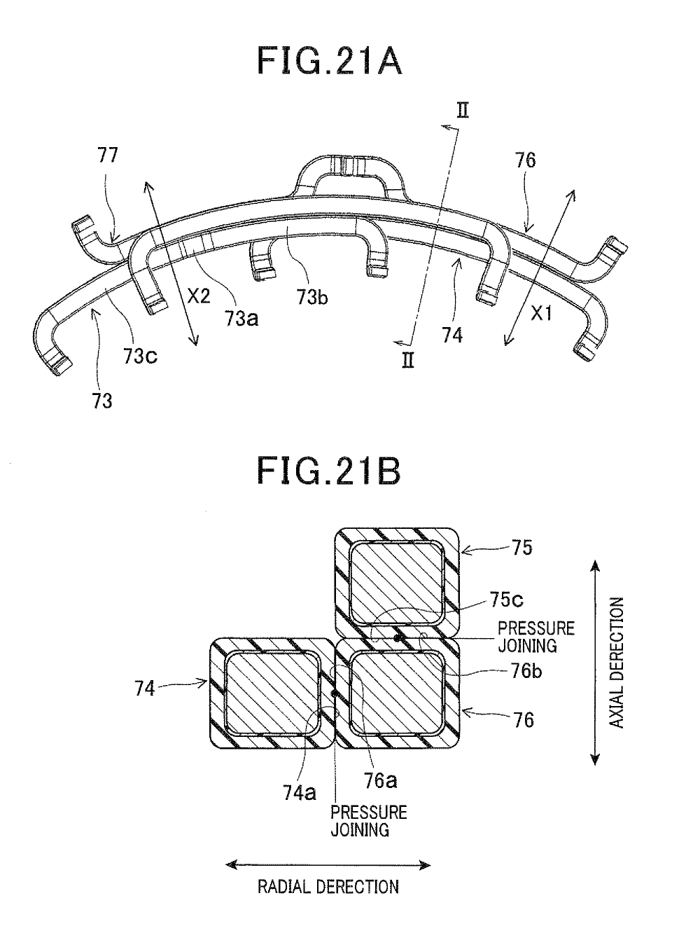

Specifically, as shown in FIG. 21A, the first to the fifth bridging wires 73-77 according to the present embodiment are respectively identical to those according to the first embodiment. Moreover, the relative arrangement of the first to the fifth bridging wires 73-77 according to the present embodiment is the same as that according to the first embodiment.

Accordingly, in the present embodiment, for each of the first to the fifth bridging wires 73-77, the main portion of the bridging wire partially overlaps at least one of the main portions of the other bridging wires either in the axial direction or in the radial direction of the stator core 30. Moreover, each pair of the overlapping parts of the main portions of the first to the fifth bridging wires 73-77 are pressed and thereby joined together.

For example, as shown in FIG. 21B, the main portion of the second bridging wire 74 partially overlaps the main portion of the fourth bridging wire 76 in the radial direction of the stator core 30, so that a flat side surface 74a of the second bridging wire 74 faces a flat side surface 76a of the fourth bridging wire 76 in the radial direction. The overlapping parts of the main portions of the second and fourth bridging wires 74 and 76 are pressed together in the radial direction, so that the flat side surfaces 74a and 76a of the bridging wires 74 and 76 are joined together. Moreover, the main portion of the third bridging wire 75 partially overlaps the main portion of the fourth bridging wire 76 in the axial direction of the stator core 30, so that a flat side surface 75c of the third bridging wire 75 faces a flat side surface 76b of the fourth bridging wire 76 in the axial direction. The overlapping parts of the main portions of the third and fourth bridging wires 75 and 76 are pressed together in the axial direction, so that the flat side surfaces 75c and 76b of the bridging wires 75 and 76 are joined to each other.

As described above, in the present embodiment, the first to the fifth bridging wires 73-77 are fixed to one another by pressure joining the overlapping parts of the bridging wires 73-77. Consequently, when the first to the fifth bridging wires 73-77 come to vibrate during operation of the electric rotating machine, the vibration of the bridging wires 73-77 will be attenuated by the friction force between each pressure-joined pair of the bridging wires 73-77. As a result, it is possible to reliably prevent adjacent pairs of the bridging wires 73-77 from colliding or sliding against each other, thereby ensuring high insulation properties of the stator coil 40.

Moreover, it is possible to interpose elastic members between the overlapping parts of the first to the fifth bridging wires 73-77.

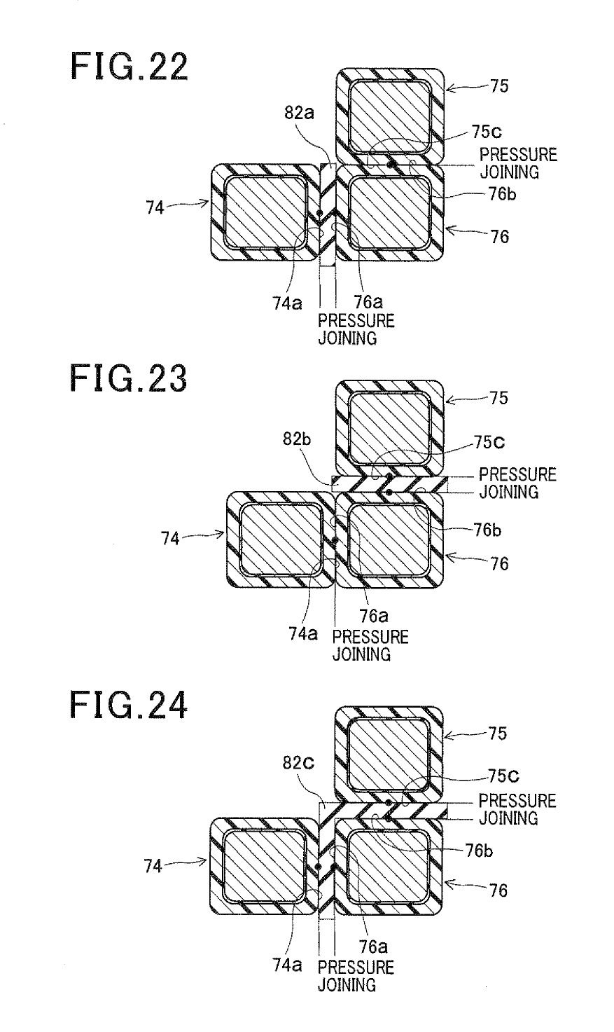

For example, in a first modification shown in FIG. 22, a flat elastic member 82a is interposed between the side surfaces 74a and 76a of the second and fourth bridging wires 74 and 76 and pressed together with the bridging wires 74 and 76. Consequently, the side surfaces 74a and 76a are pressure-joined to each other via the elastic member 82a interposed therebetween.

In a second modification shown in FIG. 23, a flat elastic member 82b is interposed between the side surfaces 75c and 76b of the third and fourth bridging wires 75 and 76 and pressed together with the bridging wires 75 and 76. Consequently, the side surfaces 75c and 76b are pressure-joined to each other via the elastic member 82b interposed therebetween.

In a third modification shown in FIG. 24, a substantially L-shaped elastic member 83c has a first portion interposed between the side surfaces 74a and 76a of the second and fourth bridging wires 74 and 76 and a second portion interposed between the side surfaces 75c and 76b of the third and fourth bridging wires 75 and 76, and is pressed together with the bridging wires 74-76. Consequently, the side surfaces 74a and 76a of the second and fourth bridging wires 74 and 76 are pressure-joined to each other via the first portion of the elastic member 83c interposed therebetween; the side surfaces 75c and 76b of the third and fourth bridging wires 75 and 76 are pressure-joined to each other via the second portion of the elastic member 83c interposed therebetween.

In addition, the elastic members 82a, 82b and 82c in the above modifications may be made of, for example, rubber.

By interposing the elastic members between the overlapping parts of the first to the fifth bridging wires 73-77, it is possible to the following additional effects. When the bridging wires 73-77 come to vibrate during operation of the electric rotating machine, the elastic members will absorb the vibration of the bridging wires 73-77. As a result, it is possible to more reliably prevent adjacent pairs of the bridging wires 73-77 from colliding or sliding against each other.

### Third Embodiment

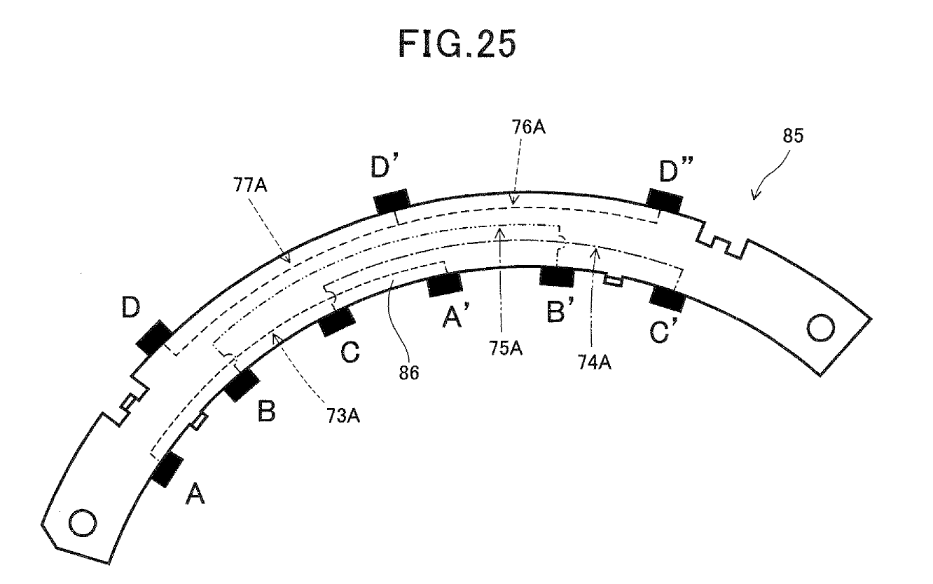

In this embodiment, the stator 20 includes a connector 85 as shown in FIG. 25. The connector 85 is made by insert-molding first to fifth bridging wires 73A-77A in a resin 86. That is, the first to the fifth bridging wires 73A-77A are fixed to one another in the resin 86.

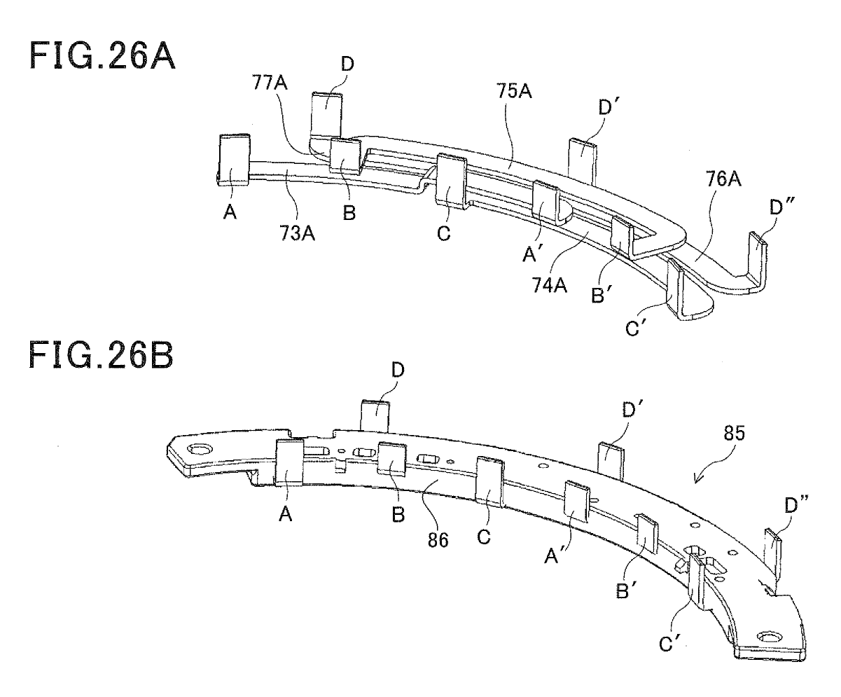

Specifically, as shown in FIG. 26A, the first to the fifth bridging wires 73A-77A are almost respectively identical to the first to the fifth bridging wires 73-77 according to the first embodiment. Moreover, the relative arrangement of the first to the fifth bridging wires 73A-77A is the same as that of the first to the fifth bridging wires 73-77. However, unlike in the first embodiment, the fourth and fifth bridging wires 76A and 77A are joined together to form a common end portion D′ thereof.

Moreover, as shown in FIGS. 25 and 26B, the connector 85 has, as a whole, an arc shape conformed to the annular shape of the coil end part 42a of the stator coil 40. The first to the fifth bridging wires are insert-molded in the resin 86 so that: the end portions A and A′ of the first bridging wire 73A, the end portions C and C′ of the second bridging wire 74A and the end portions B and B′ of the third bridging wire 75A protrude outside the resin 86 on the radially inner periphery of the connector 85; and the end portion D″ of the fourth bridging wire 76A, the end portion D of the fifth bridging wire 77A and the common end portion D′ of the fourth and fifth bridging wires 76A and 77A protrude outside the resin 86 on the radially outer periphery of the connector 85.

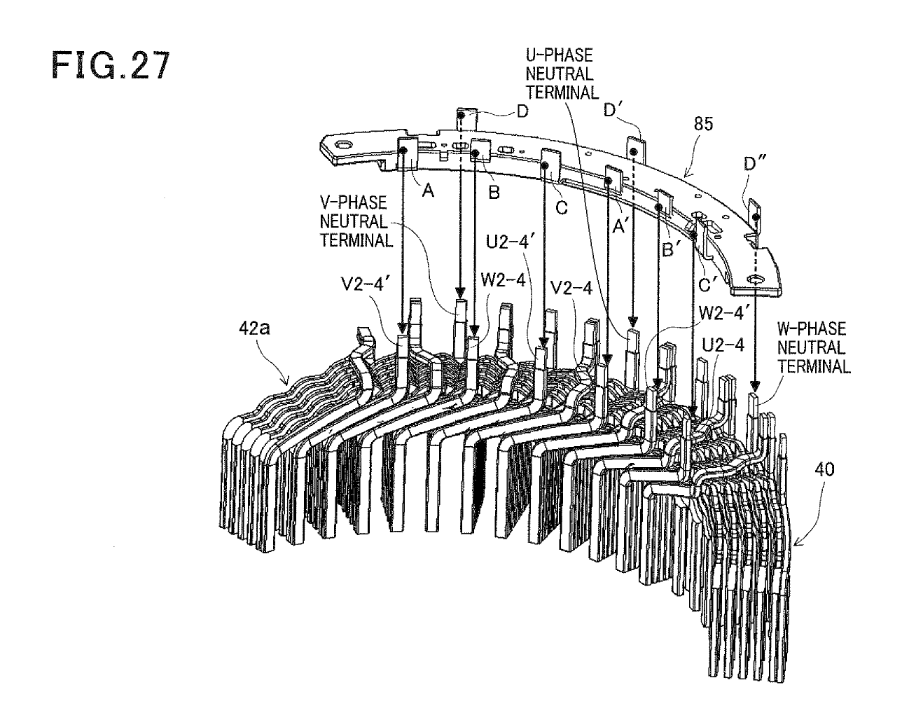

Referring now to FIG. 27, the connector 85 is mounted to the stator coil 40 by welding the end portions A-D, A′-D′ and D″ of the first to the fifth bridging wires 73A-77A respectively to corresponding ends of the electric wires 50 which are positioned on either the radially inner or the radially outer periphery of the coil end part 42a of the stator coil 40. Specifically, the end portions A and A′ of the first bridging wire 73A are respectively welded to the twelfth in-slot portion 51L-side ends of the (V2-4′) and (V2-4) electric wires 50 which are positioned on the radially inner periphery of the coil end part 42a of the stator coil 40. The end portions C and C′ of the second bridging wire 74A are respectively welded to the twelfth in-slot portion 51L-side ends of the (U2-4′) and (U2-4) electric wires 50 which are positioned on the radially inner periphery of the coil end part 42a. The end portions B and B′ of the third bridging wire 75A are respectively welded to the twelfth in-slot portion 51L-side ends of the (W2-4) and (W2-4′) electric wires 50 which are positioned on the radially inner periphery of the coil end part 42a. The end portion D″ of the fourth bridging wire 76A, the end portion D of the fifth bridging wire 77A and the common end portion D′ of the fourth and fifth bridging wires 76A and 77A are respectively welded to the W-phase, V-phase and U-phase neutral terminals. The U-phase, V-phase and W-phase neutral terminals are respectively made up of the first in-slot portion 51A-side ends of the (U1-1′), (V1-1′) and (W1-1′) electric wires 50, all of which are positioned on the radially outer periphery of the coil end part 42a of the stator coil 40. In addition, the welding of the end portions A-D, A′-D′ and D″ of the first to the fifth bridging wires 73A-77A to the corresponding ends of the electric wires 50 is performed in the same stage as the welding of the corresponding pairs of the lead portions 53a and 53b of the electric wires 50.

As above, in the present embodiment, the main portions of the first to the fifth bridging wires 73A-77A are embedded in the resin 8, thereby being mechanically joined together. Consequently, during operation of the electric rotating machine, it is possible to effectively suppress displacement of the first to the fifth bridging wires 73A-77A due to vibration of the stator 20. As a result, it is possible to reliably prevent adjacent pairs of the bridging wires 73A-77A from colliding or sliding against each other, thereby ensuring high insulation properties of the stator coil 40.

Moreover, in the present embodiment, the first to the fifth bridging wires 73A-77A are integrated into the connector 85. Consequently, during the mounting of the connector 85 to the stator coil 40, it is possible to easily position the end portions A-D, A′-D′ and D″ of the bridging wires 73A-77A with respect to the corresponding ends of the electric wires 50.

While the above particular embodiments and modifications of the invention have been shown and described, it will be understood by those skilled in the art that various further modifications, changes, and improvements may be made without departing from the spirit of the invention.

For example, in the first embodiment, all of the first to the fifth bridging wires 73-77 are fixed to one another.

However, it is also possible to fix together only the first and third bridging wires 73 and 75 which are positioned axially outermost in the bridging wires 73-77. In this case, the other bridging wires 74 and 76-77, which are axially interposed between the coil end part 42a of the stator coil 40 and the bridging wires 73 and 75, are restricted in axial movement by the coil end part 42a and the bridging wires 73 and 75. Consequently, during operation of the electric rotating machine, it is still possible to suppress displacement of the first to the fifth bridging wires 73-77 due to vibration of the stator 20.

Otherwise, it is also possible to fix only one of the fourth and fifth bridging wires 76 and 77 to an adjacent one of the first to the third bridging wires 73-75. In other words, it is possible to fix together only two of the first to the fifth bridging wires 73-75, the fixed-together two bridging wires including one of the fourth and fifth bridging wires 76 and 77. As described previously, the fourth bridging wire 76 electrically connects the U-phase and W-phase neutral terminals, while the fifth bridging wire 77 electrically connects the U-phase and V-phase neutral terminals. Therefore, in this case, it is possible to ensure reliable electric connection between the U-phase, V-phase and W-phase neutral terminals, thereby reliably defining the natural point of the stator coil 40.

What is claimed is:

1. A stator for an electric rotating machine, the stator comprising:
an annular stator core having a plurality of slots that are formed in a radially inner surface of the stator core and spaced in a circumferential direction of the stator core; and
a stator coil formed of a plurality of electric wires mounted on the stator core, the stator coil having a coil end part that protrudes from an axial end face of the stator core so as to be located outside the slots of the stator core,
wherein
the electric wires forming the stator coil are grouped into a plurality of electric wire sets,
each of the electric wire sets consists of a predetermined number of the electric wires which are electrically connected to one another,
the stator coil further includes a plurality of bridging wires,
each of the bridging wires extends, on an axially outer periphery of the coil end part of the stator coil, to electrically connect a corresponding pair of the electric wire sets, and
at least two of the bridging wires are fixed to one another.

2. The stator as set forth in claim 1, wherein the at least two bridging wires are fixed to one another by a fixing material provided therebetween.

3. The stator as set forth in claim 2, wherein the fixing material is a resin.

4. The stator as set forth in claim 3, wherein the resin is a thermosetting resin.

5. The stator as set forth in claim 2, wherein the fixing material is provided between a facing pair of flat side surfaces of the at least two bridging wires so as to keep the side surfaces parallel to each other.

6. The stator as set forth in claim 1, wherein the at least two bridging wires are pressure-joined to one another.

7. The stator as set forth in claim 6, wherein an elastic member is interposed between the at least two bridging wires.

8. The stator as set forth in claim 1, wherein the at least two bridging wires which are fixed to one another comprise those two of the plurality of bridging wires which are positioned axially outermost in all the bridging wires.

9. The stator as set forth in claim 1, wherein the stator coil is a three-phase stator coil,
among the plurality of electric wire sets, three of them each have a neutral terminal formed therein,
the neutral terminals are connected together to define a neutral point of the stator coil, and
the at least two bridging wires which are fixed to one another comprise one of the plurality of bridging wires which electrically connects two of the neutral terminals.

10. The stator as set forth in claim 1, wherein all of the plurality of bridging wires are fixed to one another.

11. The stator as set forth in claim 1, wherein each of the plurality of bridging wires is comprised of an electric conductor and an insulating coat that covers the electric conductor.

12. The stator as set forth in claim 1, wherein each of the plurality of bridging wires has a substantially rectangular cross section perpendicular to a longitudinal direction of the bridging wire, and
the at least two bridging wires have their respective side surfaces fixed to each other.

13. The stator as set forth in claim 12, wherein each of the plurality of bridging wires has a pair of wider side surfaces and a pair of narrower side surfaces, the wider side surfaces having a larger width than the narrower side surfaces, and
the at least two bridging wires have their respective wider side surfaces fixed each other.

14. The stator as set forth in claim 1, wherein the stator core is comprised of a plurality of stator core segments that are fixed together so as to adjoin one another in the circumferential direction of the stator core.

15. The stator as set forth in claim 1, further comprising a connector that includes a resin in which the plurality of bridging wires are insert-molded.
